(19) United States
(12) Patent Application Publication
(10) Pub. No.: US 2016/0189387 A1
(43) Pub. Date: Jun. 30, 2016

(54) Methods and Apparatus for Depth Sensing

(71) Applicant: Lensbricks Technology Private Limited, Bangalore (IN)

(72) Inventors: Rajeswari Kannan, Bangalore (IN); Pranav Mishra, Bangalore (IN); Ashish Rao, Bangalore (IN); Vivek Boominathan, Houston, TX (US); Ashok Veeraraghavan, Houston, TX (US); Ramesh Raskar, Cambridge, MA (US)

(21) Appl. No.: 14/583,059

(22) Filed: Dec. 24, 2014

(51) Int. Cl. G06T 7/00

(52) U.S. Cl. CPC G06T 7/0075; G06T 7/0073; G06T 7/0057; G06T 2207/10012; G06T 2207/10028; G06T 2207/20068; G06T 2207/10152

(57) ABSTRACT

In exemplary implementations of this invention, a depth-sensing system includes multiple light sources, multiple cameras, a pattern generator and one or more computers. The system measures depth in a scene. The multiple light sources emit light that illuminates a pattern generator. The pattern generator refracts, reflects or selectively attenuates the light, to create a textured light pattern that is projected onto the scene. The multiple cameras capture images of the scene from different viewpoints, while the scene is illuminated by the textured light. One or more computers process the images and compute the depth of points in the scene, by a computation that involves stereoscopic triangulation.

### FIELD OF THE TECHNOLOGY

The present invention relates generally to depth sensing.

### SUMMARY

In exemplary implementations of this invention, a system includes multiple light sources, multiple cameras, a pattern generator and one or more computers. The system measures depth (distance to points in a scene).

Light from the multiple light sources illuminates the pattern generator. The pattern generator refracts, reflects or selectively attenuates the light, to create textured visual patterns. The pattern generator projects the textured light onto the scene. The multiple cameras capture images of the scene from different viewpoints, while the scene is illuminated by the textured light. One or more computers process the images and compute the depth of points in the scene, by a computation that involves stereoscopic triangulation.

The multiple cameras image a scene from different vantage points. The multi-view data captured by these cameras is used for the stereoscopic triangulation. For example, in some cases, the multiple cameras comprise a pair of cameras.

In some cases, each of the multiple cameras has a wide field of view (FOV). The ability to measure depth over a wide FOV is advantageous for many applications. For example, in some cases, this invention is installed in a store, restaurant, lobby, public transit facility, or other wide space where it is desirable to measure depth over a wide FOV.

In illustrative implementations, the multiple light sources are positioned at different angles from the pattern generator. Thus, they illuminate the pattern generator from different angles. In some cases, the wider the range of angles at which they illuminate the pattern generator, the wider the range of angles of light projected by the pattern generator.

In illustrative implementations, the field of illumination (FOI) of the projected textured light is controllable. For example, in some cases, actuators translate the light sources (in a direction that is not directly toward or directly away from the pattern generator), and thereby change the respective angles of the translated light sources relative to the pattern generator. This, in turn, changes the angles at which light exits the pattern generator, and thus changes the FOI.

Furthermore, in some cases: (a) the light sources are directional (emit a greater radiance in some directions than in others); and (b) actuators rotate a directional light source (e.g., such that radiance emitted by the light source in the direction of the pattern generator is greater immediately after the rotation than immediately before the rotation).

A well-known problem with conventional stereoscopic depth ranging is that it is difficult to accurately measure the depth of regions of a scene that have zero or low visual texture. For example, a flat wall with uniform visual features has very little visual texture. Thus, it would be difficult, with conventional stereoscopic depth ranging, to accurately measure depth of points on such a wall.

This invention mitigates this low-texture problem by projecting a textured light pattern onto the scene. For example, in some cases, the textured pattern comprises bright dots or patches, sharp edges, or other features with a high spatial frequency. The pattern generator creates these patterns, when illuminated by the light sources. The projected light patterns add visual texture to the scene.

In some cases: (a) the pattern generator comprises a refractive optical element; and (b) the pattern generator refracts light (from the light sources) to create the visual texture. For example, in some cases, the refractive optical element creates caustic light patterns that add texture to the scene.

In other cases: (a) the pattern generator comprises a reflective optical element; and (b) the pattern generator reflects light (from the light sources) from a specular surface of the pattern generator, in order to create the visual texture. For example, in some implementations, the specular surface is uneven (with “hills” and “valleys”).

In other cases, the pattern generator comprises a spatial light modulator (SLM) and the textured light comprises light that passes through the SLM. For example, in some implementations, the SLM is a pinhole mask, and the textured light pattern is an array of dots of light, which correspond to the holes in the mask.

In some implementations of this invention, a lens is used to widen the FOI. Light from one or more of the light sources passes through, and is diverged by, the lens. The lens may be placed either in front of or behind the pattern generator.

A problem with projecting a textured light pattern onto a distant scene plane is that the resolution of the textured pattern decreases as depth increases (i.e., as distance from the pattern generator to the scene plane increases).

In some implementations, to mitigate this resolution problem, one or more lenses are used to create virtual images of the light sources. For each actual light source: (a) a lens is positioned between the actual light source and the lens, such that the distance between the lens and the light source is less than the focal length of the lens; (b) the lens creates a virtual image of the light source; and (c) the distance between the virtual image and the pattern generator is greater than the distance between the actual light source and the pattern generator. This optical setup (with the lens) causes the projected light texture to have a greater resolution at the scene plane than it would in the absence of the lens.

In some implementations, only a single light source is used, but mirrors are employed so that the single light source appears, from the vantage point of the pattern generator, to comprise multiple light sources. Two or more mirrors are positioned so that light from the single light source reflects off the mirrors and travels to the pattern generator. The multiple mirrors create the appearance of multiple virtual light sources, when seen from the pattern generator. Light from the actual light source and virtual light sources impacts the pattern generator from different angles. For example, in some cases, if a single actual light source and two mirrors are used, then from the vantage point of the pattern generator, there appear to be three light sources (one actual and two virtual), each at a different angle from the pattern generator.

In some implementations of this invention, the multiple light sources simplify the task of registering the multiple cameras, relative to the scene being imaged. This registration is performed by turning on and off the multiple light sources, one at a time.

In some implementations, a visual display screen displays an image that conveys information about the computed depth of points in the scene. For example, in some cases, the image is a depth map.

The description of the present invention in the Summary and Abstract sections hereof is just a summary. It is intended only to give a general introduction to some illustrative implementations of this invention. It does not describe all of the details of this invention. This invention may be implemented in many other ways. Likewise, the description of this invention in the Field of the Technology section is not limiting; instead it identifies, in a general, non-exclusive manner, a field of technology to which some embodiments of this invention generally relate.

### BRIEF DESCRIPTION OF THE DRAWINGS

FIG. 1A shows a depth-sensing system.

FIG. 1B shows a depth-sensing system projecting light unto a scene.

FIG. 1C shows a light pattern projected unto a scene.

FIG. 2A shows an illumination module, with light sources arranged in a straight line.

FIG. 2B shows an illumination module, with light sources arranged in a curved line.

FIG. 2C shows an illumination module, with light sources arranged in a circle.

FIG. 2D shows an illumination module, with light sources arranged in a square.

FIG. 2E shows an illumination module, with a regular array of light sources.

FIG. 2F shows an illumination module, with an irregular array of light sources.

FIG. 2G is a conceptual diagram of a spatial arrangement of light sources.

FIG. 3A shows an illumination module that includes an active light source and mirrors.

FIG. 3B shows a polygonal pattern of mirrors.

FIG. 3C shows curved specular surfaces.

FIG. 3D shows mirrors positioned behind an active light source.

FIG. 3E shows mirrors positioned in front an active light source.

FIG. 3F is a conceptual diagram of an illumination module.

FIG. 4A shows an actuator translating an object.

FIG. 4B shows an actuator rotating an object.

FIG. 4C shows translation of two illumination sources away from each other.

FIG. 4D shows translation of a pattern generator toward light sources.

FIG. 4E shows translation of a lens.

FIGS. 5A and 5B show a light pattern projected on a scene. In FIG. 5A, the size of a projected pattern is small. In FIG. 5B, the size of a projected pattern is large.

FIG. 5C shows an example of using a lens to control FOI.

FIG. 5D shows rotation of a directional light source to control FOI.

FIG. 5E shows a zoomed view of an actuator rotating a directional light source.

FIG. 5F shows an example of using mirrors to control FOI.

FIG. 6A shows a pattern generator that comprises a pinhole mask.

FIG. 6B shows a cross-section of a pattern generator that comprises an LCD (liquid crystal display).

FIG. 6C shows a cross-section of a reflective pattern generator. The pattern generator has an uneven specular surface with “hills” and “valleys”.

FIG. 6D shows a mirror for relaying light from a reflective pattern generator.

FIG. 6E shows a pattern generator that comprises a refractive optical element.

FIG. 6F shows a pattern generator that creates a visual pattern with significantly non-uniform intensity.

FIG. 7A shows a scene under base illumination.

FIGS. 7B and 7C each show patterns of light projected onto the scene.

FIG. 7D shows a visual display screen displaying a depth map.

FIG. 7E is a chart showing the magnitude of attributes of input light and output light, in an illustrative implementation.

FIG. 8A is a diagram of hardware used in this invention.

FIG. 8B is a diagram of a user interface module.

FIG. 8C is a conceptual diagram of a projector.

FIG. 9 is a flowchart of steps of a depth-sensing method.

FIG. 10 is a conceptual diagram of an LoG (LaPlacian of a Gaussian) mask.

The above Figures show some illustrative implementations of this invention, or provide information that relates to those implementations. However, this invention may be implemented in many other ways.

### DETAILED DESCRIPTION

### Overview

In illustrative embodiments of this invention, a depth-sensing system includes multiple light sources, multiple cameras, a pattern generator and a computer.

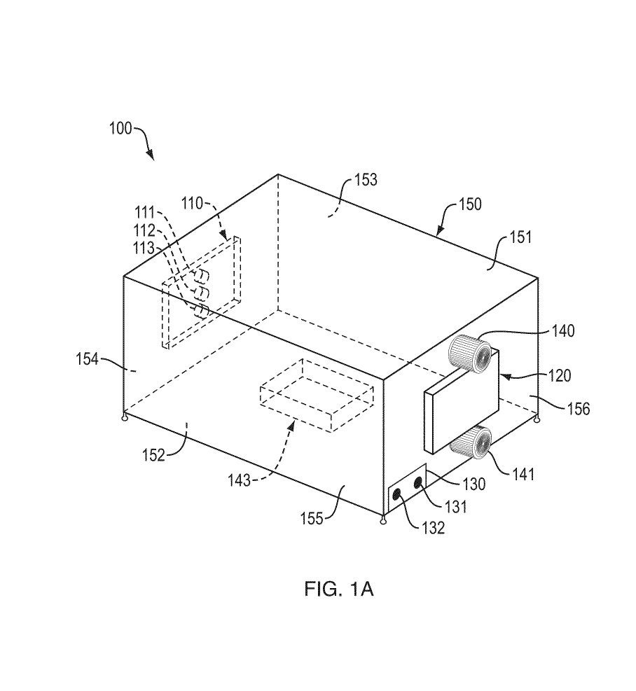

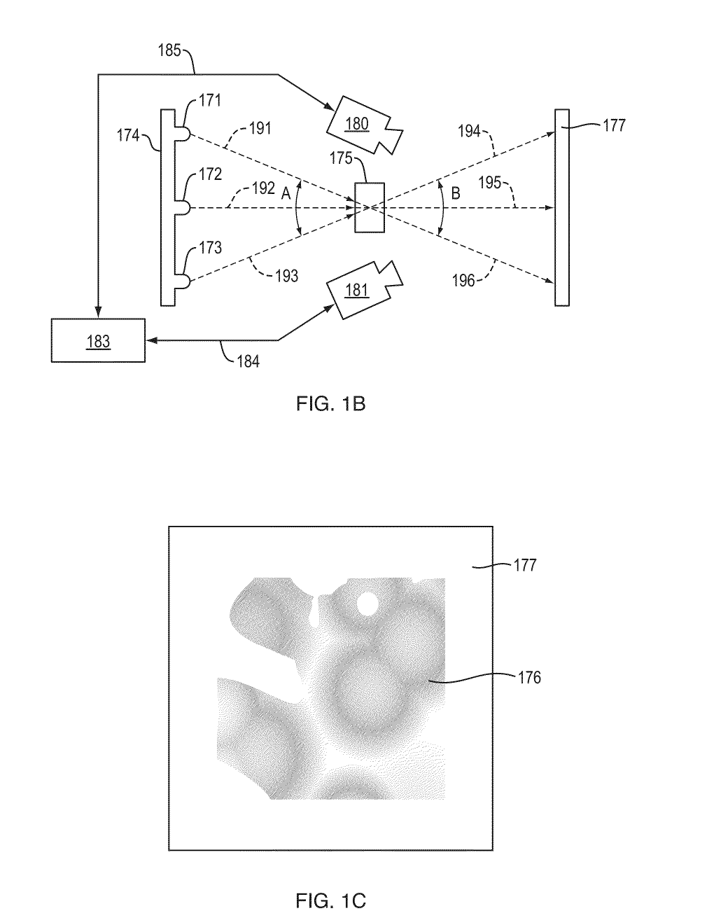

FIG. 1A shows a depth-sensing system 100, in an illustrative embodiment of this invention. In FIG. 1A, an illumination module 110 comprises three active light sources 111, 112, 113. The three active light sources are light-emitting diodes (LEDs). The active light sources 111, 112, 113 illuminate a pattern generator 120. When the pattern generator 120 is illuminated by the illumination module 110, the pattern generator 120 projects textured light onto a scene (not shown). While the scene is illuminated by the textured light, two cameras 140, 141 capture images of the scene. These images are taken from different viewpoints, because the two cameras 140, 141 are in different spatial positions relative to the scene. A computer 143 processes the images and computes the depth of points in the scene, by a computation that involves stereoscopic triangulation. An input module 130 comprises two buttons 131, 132 for accepting input from a human user.

A housing 150 houses or structurally supports the components of the depth-sensing device 100. The housing 150 includes a top wall 151, bottom wall 152, and four side walls 153, 154, 155, 156. A user input module 130 comprises two buttons 131, 132 for receiving input (e.g., instructions) from a human user.

FIG. 1B shows a depth-sensing system projecting light unto a scene, in an illustrative embodiment of this invention. In FIG. 1B, an illumination module 174 includes multiple light sources (e.g., 171, 172, 173). Light from these sources illuminates a pattern generator 175. The pattern generator 175 modifies this light, and projects a textured light pattern 176 (shown in FIG. 1C) unto a scene 177. Two cameras 180, 181 capture images of the scene while it is illuminated with the textured light. A computer 183 processes the stereo images to compute depth of the scene 177, by using triangulation. The computer 183 is connected to the cameras 180, 181 by wired or wireless connections 185, 184, respectively.

In the example shown in FIG. 1B, the range of angles (e.g., angle A) at which light strikes the pattern generator 175 is wide. Likewise, the range of angles (e.g., angle B) at which light leaves the pattern generator 175 is wide. For example, in some cases, angles A and B are each greater than 50 degrees.

FIG. 1C is a view (from the vantage point of the pattern generator) of the textured light pattern 176 projected by the pattern generator 175 onto scene 177. The texture pattern shown in FIG. 1C is merely an example; alternatively, other texture patterns of light are used.

The setups shown in FIGS. 1A and 1B have the following three advantages (among others).

First, the light sources (e.g., 111, 112, 113, 171, 172, 173) are each at a different direction from the pattern generator. Thus, the light from these light sources strikes the pattern generator 120, 175 over a range of directions. This, in turn, causes the field of illumination of the textured light projected by the pattern generator 120, 175 to be wider than it would be if the pattern generator were illuminated by light from only one direction (e.g., from only one light source). A wide field of illumination is helpful in many scenarios, such as determining depth in a large room (e.g., in a store, restaurant, lobby or other public space).

Second, the pattern generator projects textured light unto the scene. The visual texture added by the projected light makes it easier to determine the depth of scene features that otherwise would have little or no visual texture. The projected texture makes it easier to determine corresponding points in the multi-view images.

For example, consider a region of the scene (such as a flat, visually uniform surface of a wall) with little or no visual texture. The absence of texture makes it difficult to find corresponding points in two stereo images of the scene (e.g., a pair of images, one taken by camera 140, the other taken by camera 141). The textured light projected by the pattern generator 120 mitigates this problem. For example, in some cases, the textured light pattern includes feature points that are easily identifiable in both images, thereby simplifying the task of finding corresponding points. In illustrative implementations, finding corresponding points in images taken by different cameras is a step in measuring depth in a scene by triangulation.

Third, the multiple light sources make it easy to register stereo images, as described in more detail below.

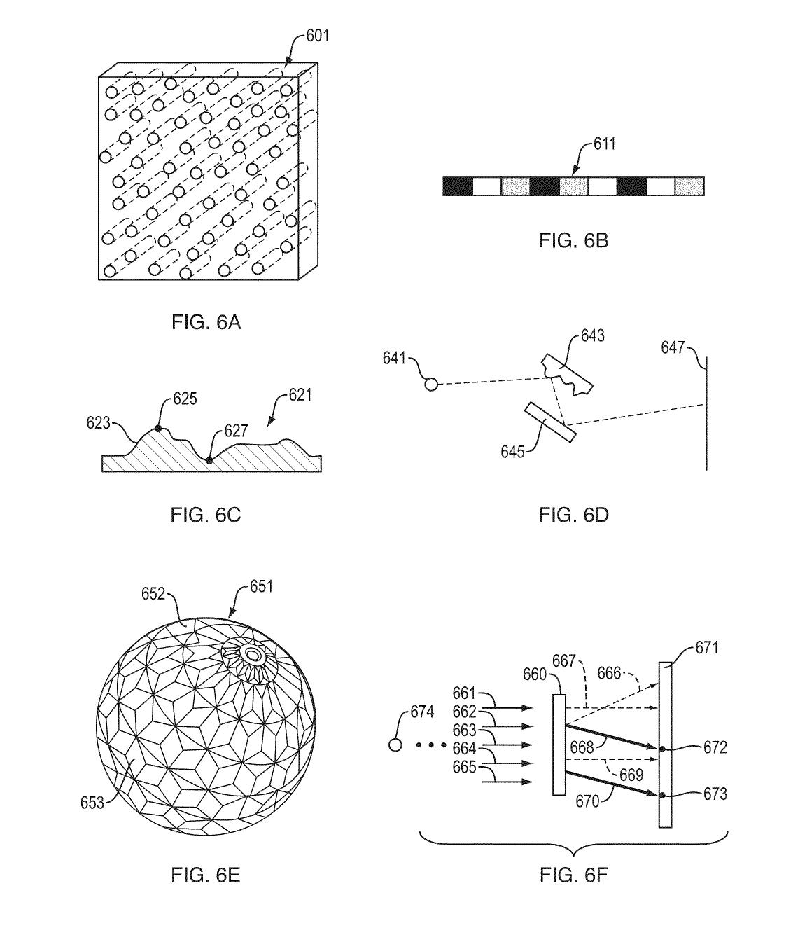

For ease of illustration, in FIGS. 1B, 4C, 5C, 5D, 5F and 8A, light rays are shown passing through a region of the pattern generator that does not block or alter the angle of the light rays. This would occur if the region were non-refractive and transmitted light without attenuation (e.g., if the region were a hole in a pinhole mask). Of course, this is not always the case (e.g., FIGS. 6D, 6F): In some cases, the pattern generator is a specular surface or refractive optical element, and the angles of at least some of the light rays are altered by the pattern generator. In other cases, the pattern generator is an SLM, and a portion of the light rays are blocked. However, the general concept illustrated by FIG. 1A is valid for many embodiments of the invention: widening the range of angles at which incoming light impacts the pattern generator has the effect of widening the range of angles of the FOI projected by the pattern generator. The preceding sentence applies to all types of pattern generators, including reflective, refractive and SLM pattern generators.

### Illumination Sources

This invention is not limited to the type of the illumination sources (LEDs) shown in FIG. 1. In alternative embodiments of this invention, the illumination module 110 is replaced by any combination of one or more illumination sources. As used herein, an “illumination source” means an active light source or a passive light source.

In illustrative implementations of this invention, the illumination sources include one or more active light sources, such as emitting diodes (LEDs), lasers, masers, incandescent light sources, fluorescent light sources, electroluminescent light sources, other luminescent or phosphorescent light sources, gas discharge light sources (including neon lights) or plasma light sources. As used herein, an “active light source” means a light source that emits light by emission of photons. As used herein, “emission of photons” does not mean (i) reflection of light, (ii) refraction of light, or (iii) mere transmission of pre-existing light. For example, in some cases, a photon is emitted when an electron drops from a higher energy state to a lower energy state.

In some implementations, the illumination sources also include one or more passive light sources that comprise specular surfaces, such as planar mirrors, concave mirrors, convex mirrors, or optical fibers. In these implementations, light is emitted by an active light source, travels to the specular surface, reflects off the specular surface, and then travels to the pattern generator. As used herein, a “passive light source” means a specular surface.

In illustrative implementations, light shines on the pattern generator from multiple different positions. These positions are occupied by any combination of active light sources or passive light sources.

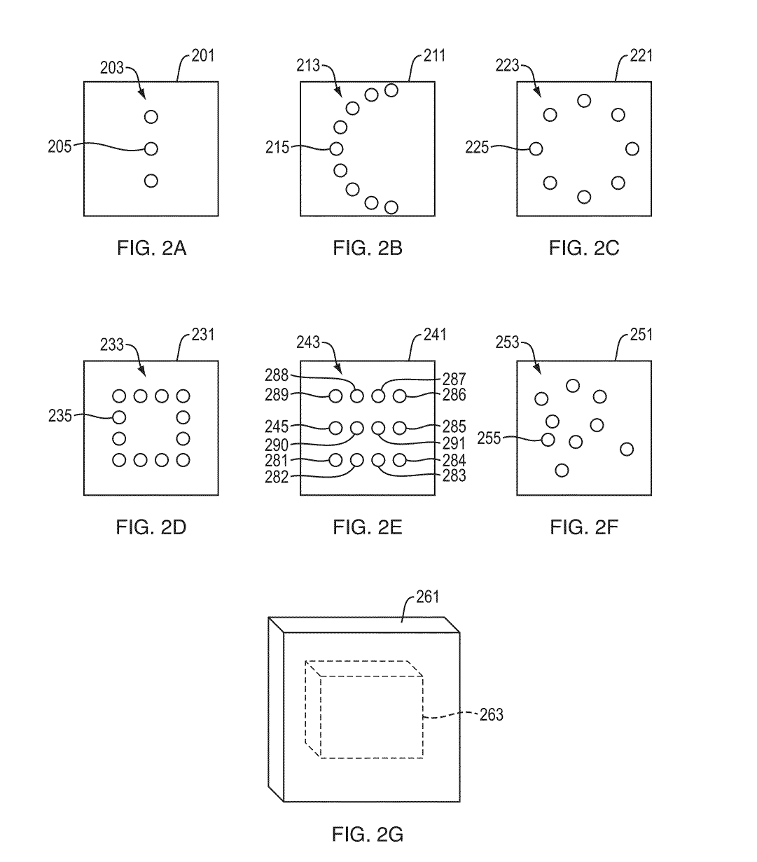

FIGS. 2A-2G show examples of spatial arrangements of illumination sources, in illustrative implementations of this invention.

FIG. 2A shows an illumination module 201 that comprises a straight line 203 of illumination sources (e.g., 205).

FIG. 2B shows an illumination module 211 that comprises a curved line 213 of illumination sources (e.g., 215).

FIG. 2C shows an illumination module 221 that comprises an elliptical pattern 223 of illumination sources (e.g., 225). In FIG. 2C, the ellipse is a circle; alternatively, the ellipse is not circular.

FIG. 2D shows an illumination module 231 that comprises a polygonal or polyhedral pattern 233 of illumination sources (e.g., 235). The pattern 233 is a square (and thus is also a rectangle and a cross-section of a polyhedron). Alternatively, any other polygonal or polyhedral pattern is used.

FIG. 2E shows an illumination module 241 that comprises a regularly-spaced array 243 of illumination sources (e.g., 245). The array 243 has three rows and four columns. Alternatively, the array has any number of rows and any number of columns.

FIG. 2F shows an illumination module 251 that comprises an irregular pattern 253 of illumination sources (e.g., 255). Alternatively, any other irregularly shaped pattern is used.

FIG. 2G shows an illumination module 261 that comprises any spatial arrangement (symbolized by box 263) of one or more illumination sources in three dimensions.

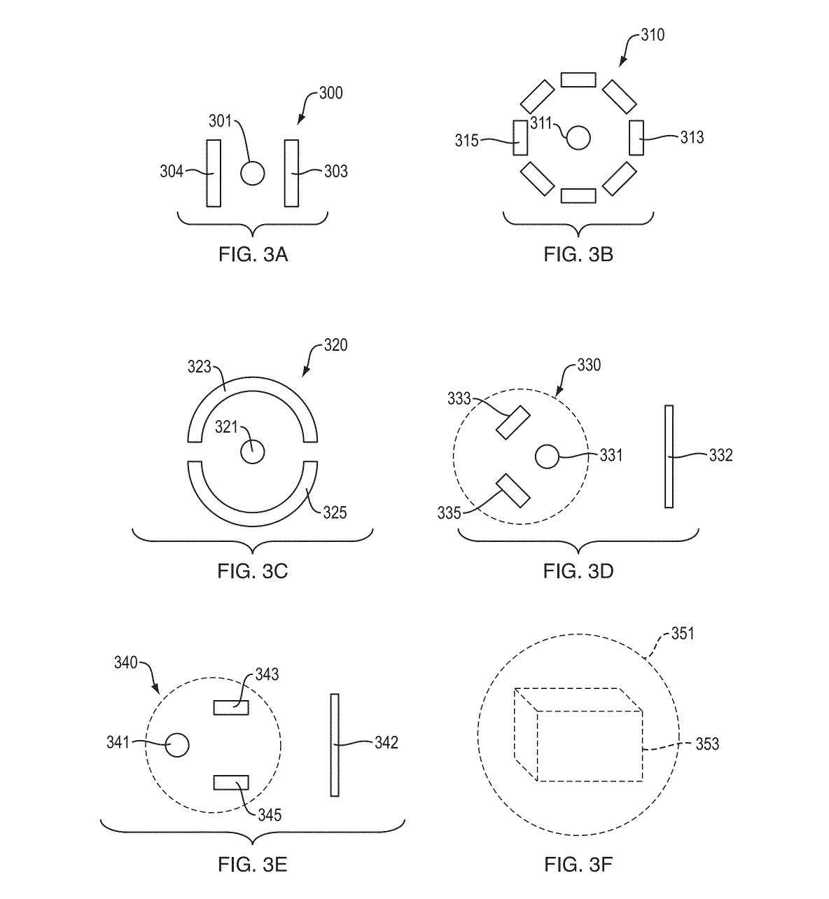

FIGS. 3A-3F show examples of the use of passive light sources, in illustrative implementations of this invention.

FIG. 3A is a view, from the vantage point of the pattern generator, of an illumination module 300. The illumination module 300 comprises an active light source 301 and two passive light sources 303, 304. Each passive light source 303, 304 is a specular surface that reflects light from the active light source 301.

FIG. 3B is a view, from the vantage point of a pattern generator, of an illumination module 310. The illumination module 310 comprises (i) an active light source 311 and (ii) a set of passive light sources (e.g., mirrors 313, 315) that are positioned on lines that are edges or faces of a polygon or polyhedron. The shape in FIG. 3B symbolizes any polygon or polyhedron, with any number of faces or edges. Each passive light source (e.g., 313, 315) in the set is a specular surface that reflects light from the active light source 311.

FIG. 3C is a view, from the vantage point of a pattern generator, of an illumination module 320. The illumination module 320 comprises (i) an active light source 321 and (ii) a set of passive light sources (e.g., mirrors 323, 325) that are positioned on, or that comprise all or part of, a curved line or curved surface. FIG. 3C shows mirrors 323, 325 positioned on parts of an annular surface. Alternatively, any other curved line or curved surface, including any other annular, convex or concave surface (including all or part of any ring, bowl, or hemisphere, or part of any paraboloid or ellipsoid) is used. Each passive light source (e.g., 323, 325) in the set is a specular surface that reflects light from the active light source 321.

FIG. 3D is a side view of an illumination module 330 that illuminates pattern generator 332. The illumination module 330 includes an active light source 331 and a set of passive light sources (e.g., mirrors 333, 335). The passive light sources (e.g., mirrors 333, 335) are located behind the active light source 331.

FIG. 3E is a side view of an illumination module 340 that illuminates pattern generator 342. The illumination module 340 includes an active light source 341 and a set of passive light sources (e.g., mirrors 343, 345). The passive light sources (e.g., mirrors 343, 345) are located in front of the active light source 341.

FIG. 3F shows an illumination module 351 that comprises any spatial arrangement (symbolized by box 353) of one or more active illumination sources and one or more passive illumination sources in three dimensions.

In illustrative embodiments, the arrangements of illumination sources shown in FIGS. 2A-3F are implemented with any number of illumination sources, not just the particular number of sources shown in those Figures. In the examples shown in FIGS. 2A to 3F, the illumination sources in a particular arrangement either are, or are not, all located in a single plane. In the examples shown in FIGS. 3A-3E, light reflects from each of the passive light sources and then travels to the pattern generator.

In illustrative implementations, one or more of active light sources emit NIR (near infrared) light or other light outside of the visible light spectrum. For example, in illustrative implementations, the illumination module includes (i) two or more NIR active light sources or (ii) at least one NIR active light source and at least one passive light source for reflecting the NIR light. Also, in these implementations, at least two cameras measure NIR light.

Advantageously, NIR is invisible to humans. Thus, human users are not distracted by the NIR light when the NIR light is projected unto to the scene to add visual texture to the scene. As used herein, “visual texture” means the texture of a pattern of light. The term “visual texture” does not imply that the pattern of light exists in the visible light spectrum. For example, in many implementations of this invention, the visual texture occurs in NIR light.

### Actuators

In illustrative implementations, a depth sensing device includes one or more actuators for translating or rotating one or more components (such as an illumination source, pattern generator, lens, or camera) of the device.

In illustrative implementations, one or more actuators control the position or orientation of one or more of the light sources, mirrors or lens. Controlling the position or orientation of these components alters the distribution of the projected light pattern over the scene being imaged. The projected light pattern provides visual texture to the scene for more accurate depth computation. Generally, walls, floor and the ceiling are places in the scene where the projected pattern is desirable. The position of the walls, floor and ceiling in the image varies from scene to scene. Therefore, actuators are useful to change the position or orientation of the light sources, mirrors or lens in order to project the pattern on those parts of the image that need virtual texture for depth computation.

In some use scenarios, the actuators translate or rotate these components (light sources, lens or mirrors) to cause the projected pattern to be concentrated in a small portion of the scene, or to be spread out over a large part of the scene, or projected in sequence from one part of the scene to another, depending on what is desirable for the particular scene.

Here are five non-limiting examples of the use of actuators, in illustrative implementations of this invention:

Actuator Example 1: In some implementations, actuators translate illumination sources (a) to move the illumination sources wider apart from each other (so that they are less densely arranged); or (b) to move the illumination sources closer together (so that they are more densely arranged). In some cases, moving the illumination sources wider apart causes the FOI to be larger; and moving them closer together causes the FOI to be smaller. More generally, translating an illumination source, in a direction other than directly at or directly away from the pattern generator, affects the size, shape or direction of the FOI.

In alternative embodiments, a set of stationary, active light sources are used. Light sources in the set are turned on and off, creating a similar effect to translating an active light source. For example, in some cases: (a) a depth-sensing device includes a stationary array of lights, and (b) a computer outputs control signals to selectively turn different lights in the set on and off, and thereby to control the range of angles at which light is incident on the pattern generator, and thereby to control the size, direction or shape of the FOI.

For example, in FIG. 2E, illumination module 241 includes an array of stationary, active light sources (245, 281-291). In an illustrative use scenario, a computer outputs control signals that cause the outer perimeter of lights (245, 281-289) to be off, and the inner two lights (290, 291) to be on. Then, the computer outputs control signals that cause the inner two lights to be off, and the outer perimeter of lights to be on. In another use scenario, a computer outputs control signals that cause the outer perimeter of lights (245, 281-289) to be off, and the inner two lights (290, 291) to be on. The computer then outputs control signals that cause the inner two lights to turn off, and lights 245 and 285 to turn on, while all of the other lights remain off.

Actuator Example 2: In some implementations, actuators rotate one or more directional illumination sources (e.g., to point a directional illumination source at the pattern generator). For example, in some cases: (a) translation of a directional illumination source causes or would cause the directional illumination source to no longer be pointed at the pattern generator; and (b) rotation is used to compensate for this effect. The rotation may follow, precede or occur concurrently with the translation. More generally, rotating a directional illumination source (e.g., to point it at, or away from, the pattern generator) affects the size, direction, or shape of the FOI.

Actuator Example 3: In some implementations, an actuator translates a pattern generator toward, or away from, an illumination module. In some cases: (a) moving the pattern generator closer to the illumination module increases the FOI; and (b) moving the pattern generator further from the illumination module decreases the FOI.

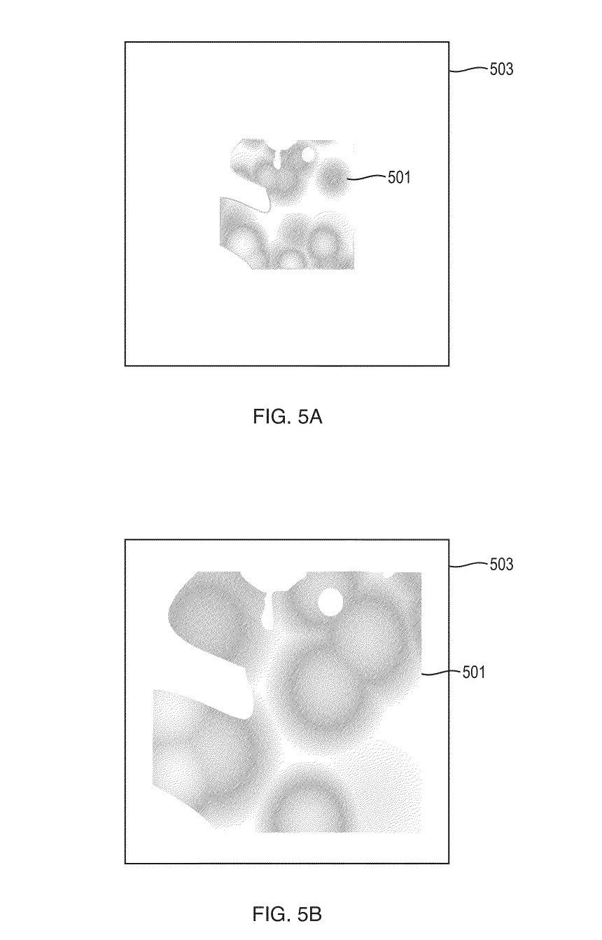

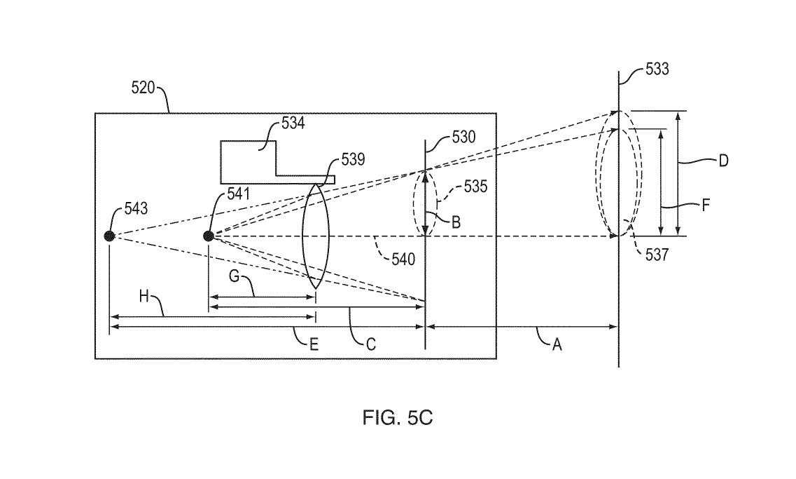

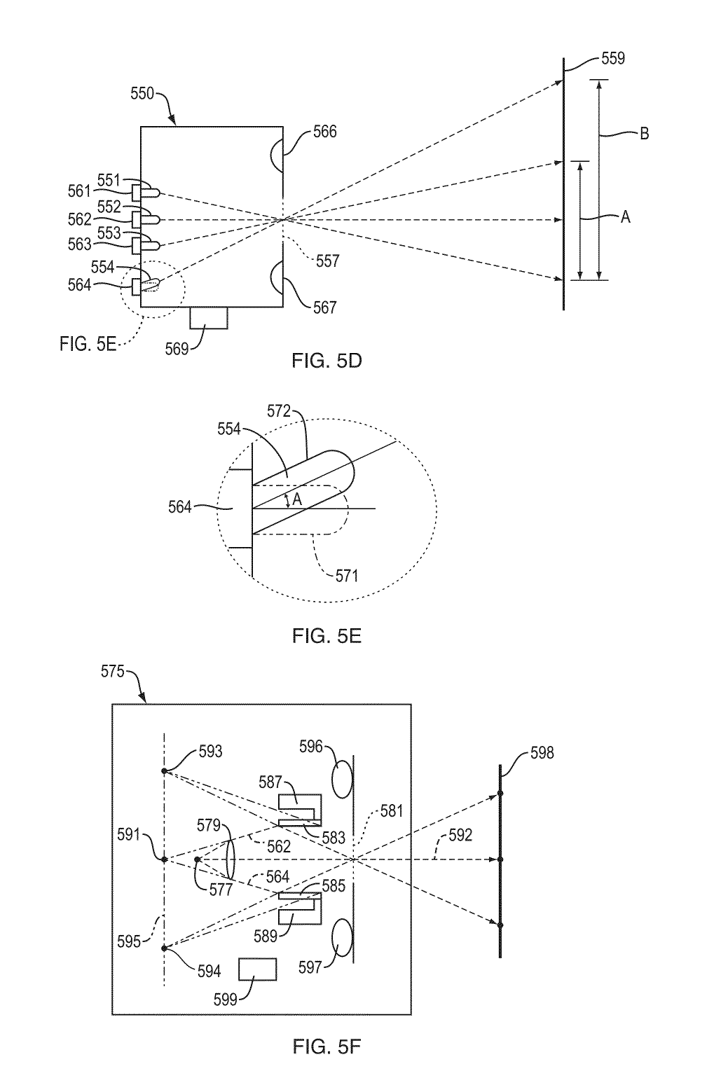

Actuator Example 4: In some implementations, an actuator translates a lens (e.g., to different positions along the optical axis of the lens). For example, in some cases: (a) the optical axis of a lens intersects an active light source and a pattern generator; (b) the actuator translates the lens to a position along the axis where the focal length of the lens is greater than the distance between the active light source and the lens; (c) in this position, the lens creates (from the vantage point of the pattern generator) a virtual image of the active light source; (d) the distance between the virtual image and the pattern generator is greater than the distance between the active light source and the pattern generator; and (e) the FOI is smaller than it would be if the lens were at the focal length. This example is illustrated in FIG. 5C, discussed below.

Actuator Example 5: In some implementations, one or more actuators rotate one or more cameras. Such rotation has many practical applications, including in the following use scenarios: (a) to rotate cameras so that they image a desired region of the scene (e.g., to image a region that is directly in from of the device, or instead to image a region that is off center); or (b) to compensate for changes in depth at which the cameras are focused. As a non-limiting illustration of the latter application, consider the following use scenario: Two cameras are pointed such that they image the same region of a scene at a first depth. If the cameras then refocus at a new, second depth, this may cause the cameras to image different (e.g., partially overlapping) regions of the scene at the second depth. Actuators may compensate, by rotating the cameras to focus at a single region at the second depth.

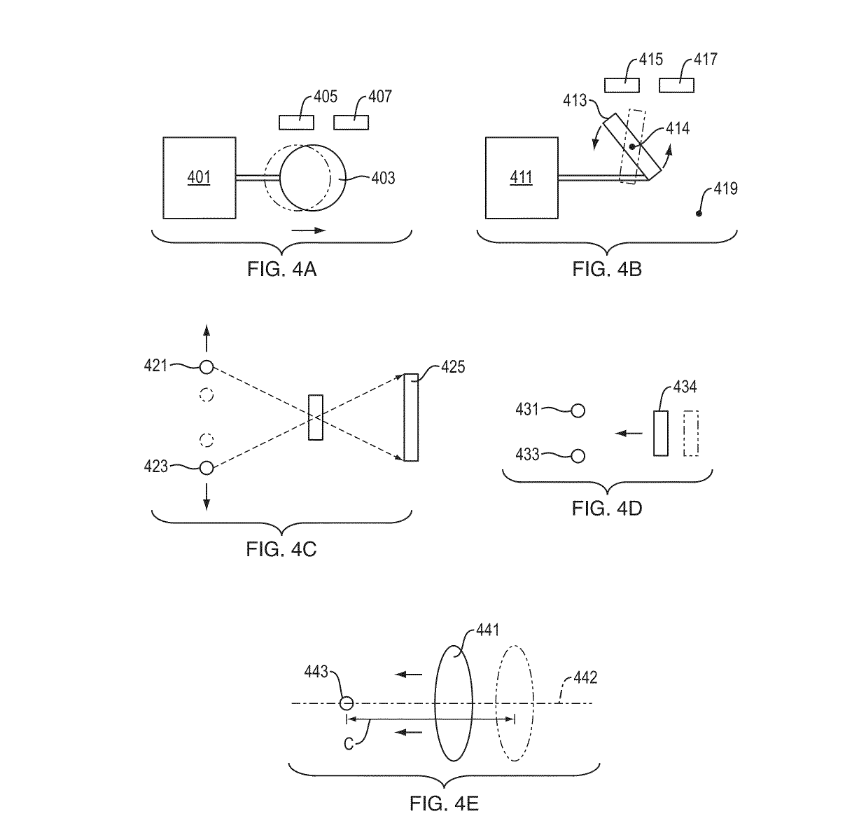

FIG. 4A shows an actuator 401 translating an object 403.

FIG. 4B shows an actuator 411 rotating an object 413. The object 413 is rotating about an axis (e.g., 414) that intersects the object 413. Alternatively, in some cases, an actuator rotates object 413 about an axis (e.g., 419) that does not intersect the object 413. Axes 414 and 419 are perpendicular to the plane of FIG. 4B.

In FIGS. 4A and 4B, the actuator 401, 411 is any kind of actuator, including a linear, rotary, electrical, piezoelectric, or electro-mechanical actuator. The actuator 401, 411 in some cases includes and is powered by an electrical motor, including any stepper motor or servomotor. One or more sensors 405, 407, 415, 417 are used to detect position, displacement or other data for feedback to the actuator. In FIGS. 4A and 4B, the object 403, 413 being translated or rotated is an illumination source, pattern generator, lens or camera.

FIG. 4C shows translation of two illumination sources 421, 423. In the example shown in FIG. 4C, moving the illumination sources 421, 423 further apart increases the size of the FOI 425. Conversely, moving the illumination sources 421, 423 closer together would decrease the size of the FOI 425.

FIG. 4D shows translation of a pattern generator 434 toward two illumination sources 431, 433. In the example shown in FIG. 4D, moving the pattern generator 434 closer to the illumination sources 431, 433 increases the size of the FOI (not shown). Conversely, in this example, moving the pattern generator 434 farther from the illumination sources 431, 433 would increase the size of the FOI (not shown).

FIG. 4E shows translation of a lens 441 along the optical axis 442 of the lens. Initially, the lens 441 is at its focal length C from an illumination source 443. After the translation, the lens 441 is at a shorter distance (i.e., a distance less than its focal length C) from the illumination source 443.

In FIGS. 4A-4E, the initial position of the object being translated (or of the FOI) is indicated by dashed lines; the ending position of the object being translated (or of the FOI) is indicated by solid lines.

### Field of Illumination

In some implementations, the light projected by the pattern generator has a wide field of illumination (FOI). For example, in some cases, the maximum angle subtended by two points in the FOI (as seen from the pattern generator) is 45 degrees, or 50 degrees, or 55 degrees, or 60 degrees, or 65 degrees, or 70 degrees, or more than 70 degrees. Angle B in FIG. 1B is an example of an angle subtended by two points in an FOI (as seen from a pattern generator).

In illustrative implementations, the illumination sources are positioned in different directions relative to the pattern generator. For example, in some cases, the maximum angle subtended by two illumination sources (as seen from a pattern generator) is 45 degrees, or 50 degrees, or 55 degrees, or 60 degrees, or 65 degrees, or 70 degrees, or more than 70 degrees. Angle A in FIG. 1B is an example of an angle subtended by two illumination sources (as seen from a pattern generator).

In illustrative implementations, increasing the size of the FOI at a given scene plane tends to decrease the resolution of the visual pattern projected by the pattern generator onto the given scene plane. Conversely, decreasing the size of the FOI at the scene plane tends to increase the resolution.

FIGS. 5A and 5B show an FOI 501 that is projected at scene plane 503. The projection of the FOI on the scene is smaller in FIG. 5A than in FIG. 5B. Furthermore, the resolution of the visual pattern in the smaller FOI is greater than the resolution of the visual pattern in the larger FOI.

Thus, in illustrative implementations, the size and shape of the FOI and the resolution of the projected visual texture pattern are controllable. In some implementations, actuators translate or rotate illumination sources or turn active light sources on and off. This in turn controls the range of directions at which light from illumination sources impact the pattern generator, which in turn controls the range of directions at which light exits the pattern generator, which in turn controls the size and shape of the FOI and the resolution of the projected visual texture.

FIG. 5C shows an example of a projector 520 using a lens 539 to control the size of an FOI. The lens 539 is interposed between a light source 541 and the pattern generator 530, at a distance from the light source 541 that is less than the focal length of the lens 539. This reduces the size of the FOI.

In the depth-sensing system shown in FIG. 5C:

D=B(1+A/C) (Eq. 1)

where A is the distance between a pattern generator 530 and a scene plane 533, B is the diameter of a pinhole 535 in the pattern generator 530, C is the distance between light source 541 and pattern generator 530, and D is the length of the FOI 537 that would be projected on scene plane 533 if lens 539 were not present.

In FIG. 5C, a positive lens 539 is positioned between light source 541 and the pattern generator 530. The positive lens 539 creates a virtual image 543 of the light source (as seen from pattern generator 530). This virtual image 543 appears to be at a distance E from the pattern generator 530.

The presence of the lens 539 causes the length of the FOI 537 to be less than it would be if the lens 539 were absent. In FIG. 5C: (a) E is the distance between virtual image 543 and the pattern generator 530; (b) F is the length of FOI 537 (projected onto scene plane 533) when lens 539 is present; (c) G is the distance between the lens 539 and the light source 541; and (d) H is the focal length of the lens 539.

In the example shown in FIG. 5C, H (the focal length of lens 539) is greater than G (the distance between light source 541 and lens 539).

In the depth-sensing system shown in FIG. 5C:

F=B(1+A/E) (Eq. 2)

As is evident from Equation 2, the limit of F (the length of the FOI when the lens is present) as E (distance between virtual image and pattern generator) approaches infinity is B (the diameter of pinhole 535). Put differently, the more that E increases, the closer that F comes to B.

In some cases, it is desirable to reduce F (length of FOI when lens is present) as close as possible to the B (the diameter of the pinhole), in order to increase the resolution of the projected pattern at scene plane 533.

Equation 2 indicates that, in the example shown in FIG. 5C, the size of the FOI 537 can be controlled by adjusting E (the distance between the virtual image and the pattern generator). In turn, E can be controlled by adjusting G (the distance between the lens 539 and the light source 541). The closer that the light source 541 is to the lens 539, the smaller the distance E (between virtual image and pattern generator), and the greater the distance F (length of FOI 537 when lens 539 is present).

In some implementations, an actuator 534 translates lens 539 along its optical axis 540. For example, in some use scenarios, actuator 533 translates lens 539 closer to the light source 541, and thereby increases the size of the FOI projected at scene plane 533 (and thus reduces the resolution the projected pattern). In other use scenarios, actuator 534 translates lens 539 away from light source 541, and thereby decreases the size of the FOI projected at scene plane 533 (and thus increases the resolution of the projected pattern).

Alternatively (or in addition), in some implementations, a lens is positioned in front of the pattern generator, at a given location between the pattern generator and the scene. For example, a negative lens at that given location will diverge light and thereby (if the given location is far enough from the scene) increase the size of the FOI as measured at the scene. In contrast, a positive lens at that given location will converge light and thereby (if the given location is far enough from the scene) decrease the size of the FOI.

FIG. 5D shows an example of an actuator changing the orientation of a directional light source. This in turn controls both the angular size of the FOI and the length of the FOI as projected onto the scene. In the depth-finding system 550 shown in FIG. 5D, four directional, active light sources 551, 552, 553, 554 illuminate a pattern generator 557, which projects textured light unto a scene 559. Cameras 566, 567 capture images of the scene 559 while the scene 559 is illuminated by the textured light. Computer 569 processes the images to determine depth of the scene 559 by triangulation. Four actuators 561, 562, 563, 564 control the orientation of the active light sources 551, 552, 553, 554, respectively.

In the example shown in FIG. 5D, directional light source 554 is originally pointed away from the pattern generator 557. Actuator 564 then rotates directional light source 554 so that this light source points at the pattern generator. This has the effect of increasing the angular size of the FOI, and thus the length of the FOI as projected onto the scene 559. In FIG. 5D, lengths A and B are the length of the projected FOI before and after, respectively, light source 554 is pointed at the pattern generator 557. Length A is less than length B.

FIG. 5E is a close-up view of the rotation of light source 554. Initially, light source 554 is in position 571. Then actuator 564 rotates light source 554, by A degrees, to position 572.

Alternatively, in some cases, another way to widen the FOI is to widen the pattern generator, or to widen a region of the pattern generator which does not block light from reaching the scene.

In some cases (such as FIG. 5F), light from a single light source passes through a lens, before reaching a pair of mirrors, and then traveling to the pattern generator. The lens is positive and is positioned such that the distance between the light source and the lens is less than the focal length of the lens. In this setup: (a) the lens creates a virtual image of the single light source, which appears, from the vantage point of the pattern generator, to be further away than the actual light source; (b) the lens causes the virtual images created by the mirrors to appear, from the vantage point of the pattern generator, to be further from the pattern generator than they would be in the absence of the lens; and (b) the lens causes the visual texture projected by the pattern generator to have a finer resolution (at a scene plane) than it would have in the absence of the lens.

FIG. 5F shows an example of using mirrors to control the angular size of the FOI and the length of the FOI as projected unto a scene. In the depth-finding system 575 shown in FIG. 5F, an active light source 577 emits light. The light passes through a positive lens 579. A first portion of the light travels directly from lens 579 to pattern generator 581. A second portion of the light travels from lens 579 to mirror 583, and then reflects from mirror 583 and travels to the pattern generator 581. A third portion of the light travels from lens 579 to mirror 585, and then reflects from mirror 585 and travels to the pattern generator 581.

In FIG. 5F, mirrors 583, 585 widen the range of angles at which incoming light impacts the pattern generator 581. If mirrors 583, 585 were removed, the range of angles at which incoming light impacts the pattern generator 581 would be less.

In FIG. 5F, mirrors 583, 585 are planar surfaces that are parallel with the optical axis 592 of lens 579. In some implementations, actuators rotate mirrors in order to control the FOI. For example, in FIG. 5F, the orientation of mirrors are controllable: actuator 587 controls the orientation of mirror 583 and actuator 589 controls the orientation of mirror 585. In some use scenarios, actuator 587 rotates mirror 583 clockwise (from the position shown in FIG. 5F to a new position) thereby widening the FOI. Later, actuator 587 rotates mirror 583 counterclockwise (from the new position back to the position shown in FIG. 5F), thereby narrowing the FOI. In some use scenarios, actuator 589 rotates mirror 585 counterclockwise (from the position shown in FIG. 5F to a second position) thereby widening the FOI. Later, actuator 589 rotates mirror 585 clockwise (from the second position back to the position shown in FIG. 5F), thereby narrowing the FOI.

In FIG. 5F, the distance between lens 579 and light source 577 is less than the focal length of lens 579. This creates a virtual image 591. The two mirrors also create two virtual images 593, 594. The three virtual images 591, 593, 594 are all located in the same plane 595.

In FIG. 5F, two cameras 596, 597 capture images of the scene 598 while the scene 598 is illuminated with the textured light. Computer 599 processes the images to determine depth of the scene 598 by triangulation.

### Pattern Generator

In illustrative implementations, the pattern generator is illuminated by incoming light. The pattern generator projects light onto a scene. The projected light adds visual texture to the scene.

In illustrative implementations, a pattern generator modifies light, such that the input light (i.e., light incident on the pattern generator) is different than the output light (i.e. outgoing light that leaves the pattern generator). As used herein: (a) “input light” means light that is incident on a pattern generator; and (c) “output light” means light that leaves a pattern generator. For example, in FIG. 1A, light rays 191, 192, 193 are rays of input light, and light rays 194, 195, 196 are rays of output light.

In illustrative implementations, modification of the light by a pattern generator can be described by at least the following seven attributes: variance, uniformity, average entropy, number of edge crossings, spatial frequency factor, or number of intensity peaks. For example:

In illustrative implementations, the shape of the pattern generator is such that the variance of the output light is substantially greater than the variance of the input light.

In illustrative implementations, the shape of the pattern generator is such that the uniformity of the output light is substantially less than the uniformity of the input light.

In illustrative implementations, the shape of the pattern generator is such that the average entropy of the output light is substantially greater than the average entropy of the input light.

In illustrative implementations, the shape of the pattern generator is such that the number of edge crossings in the output light is substantially greater than the number of edge crossings of the input light.

In illustrative implementations, the shape of the pattern generator is such that the spatial frequency factor of the output light is substantially greater than the spatial frequency factor of the input light.

In illustrative implementations, the shape of the pattern generator is such that the number of intensity peaks of the output light is substantially greater than the number of intensity peaks of the input light.

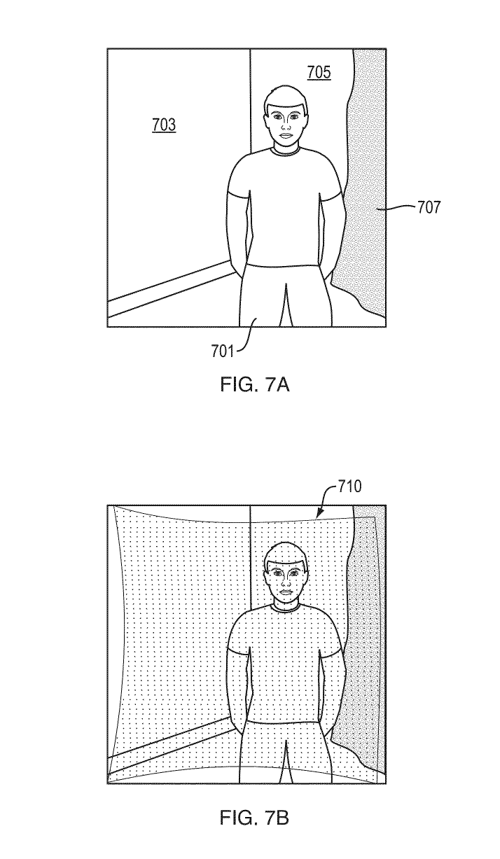

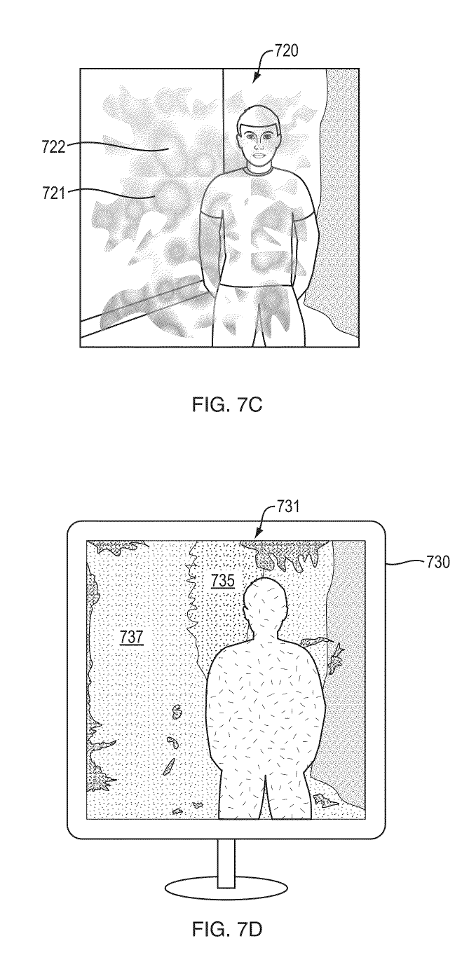

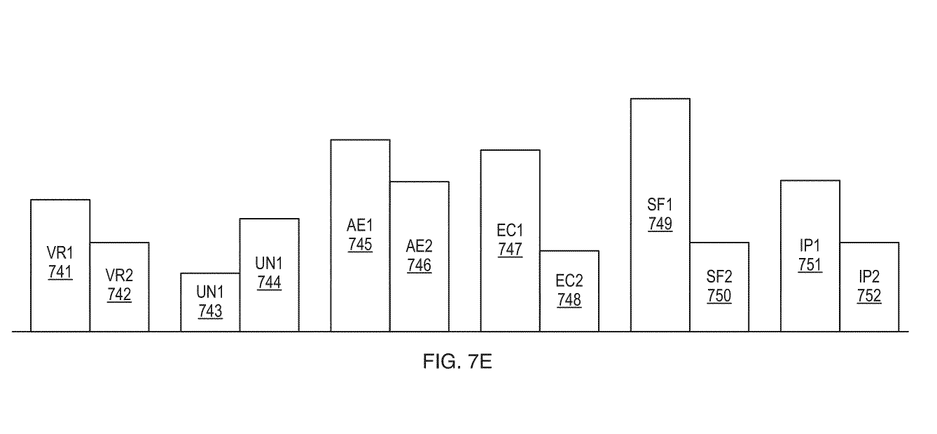

Illustrative implementations mentioned in each of the previous six paragraphs include: (a) an embodiment in which the pattern generator projects a pattern shown in FIG. 7B or FIG. 7C onto a scene, which scene has the base illumination shown in FIG. 7A; and (b) an embodiment in which the pattern generator has a shape shown in FIG. 6A, 6B, 6C or 6E.

As used herein, the “variance” of an image is the second statistical moment of the intensity histogram of the image. That is, the variance ν is defined as:

$$v = {\sum }_{i = 0}^{L - 1} {( {z}_{i} - m )}^{2} p ( {z}_{i} )$$

where Z is a random variable denoting intensity, p(zᵢ) is the corresponding intensity histogram for i=0, 1, 2, . . . , L−1, and L is the number of distinct intensity levels allowed in the digital image, and m is the mean value of Z (that is, the average intensity):

$$m = {\sum }_{i = 0}^{L - 1} {z}_{i} p ( {z}_{i} )$$

As used herein, the “uniformity” U of an image is defined as:

$$U = {\sum }_{i = 0}^{L - 1} {p}^{2} ( {z}_{i} )$$

where p(zᵢ) has the same meaning as defined above.

As used herein, the “average entropy” e of an image is defined as:

$$e = - {\sum }_{i = 0}^{L - 1} p ( {z}_{i} ) {log}_{2} p ( {z}_{i} )$$

where p(zᵢ) has the same meaning as defined above.

As used herein, the number of edge crossings in an image means the total number of times that an edge is crossed when going row-by-row across all the rows of pixels in the image, and then going column-by-column down all the columns of pixels in the image. Under this definition: (a) a single edge may have multiple edge crossings; and (b) a single pixel may be located on two edge crossings (once in a row and once in a column).

As used herein, to say that an image has “multiple edges” means that in at least one specific row or column of pixels in the image, more than one edge crossing occurs in that specific row or column. For example, under this definition, an image may be counted as having “multiple edges” if the image has an edge that forms a loop or that waves back and forth across the image.

As used herein, the “spatial frequency factor” of an image is a quantity determinable from a magnitude spectrum of a 2D DFT (Discrete Fourier Transform) of the image, where the origin of the spectrum is centered. Specifically, the “spatial frequency factor” is the length of the radius of the largest circle in the 2D DFT, which circle is centered at the origin, such that the total intensity of the pixels of the 2D DFT that are located on or outside the circle is greater than the total intensity of the pixels of the 2D DFT that are located inside the circle.

It can be helpful to standardize measurements for testing if a definition is satisfied. To say that an image is captured under “Standard Conditions” means that: (a) the digital image is a 16.1 megapixel image; (b) the digital image is an image of an entire screen and does not include any regions outside of the screen; (b) the screen is a diffuse, planar surface; (c) the screen is located 1 meter from a pattern generator, and (d) the sole source of illumination of the screen is light from a single point source of light, which point source is distant from the pattern generator, and which light travels in an optical path from the point source directly to the pattern generator, and then from the pattern generator directly to the screen.

As can be seen from the preceding definition, under Standard Conditions, a pattern generator lies in an optical path between a single distant point source of light and the scene.

It can be helpful to describe the effect of a pattern generator by comparing a first image of a screen taken when a pattern generator is projecting light onto the screen and a second image of a screen taken under identical conditions, except that the pattern generator has been removed. In other words, it can be helpful to compare a first image taken under Standard Conditions with a pattern generator present, and a second image taken under identical conditions except that the pattern generator is absent. The second image (taken with the pattern generator absent) effectively measures the input light.

As used herein, to say that “the variance of the output light is substantially greater than the variance of the input light” means that, if a first digital image of a screen were taken under Standard Conditions while the screen is illuminated by light that travels from a light source to a pattern projector and then to the screen, and a second digital image of the screen were taken under identical conditions except that the pattern generator is absent, then the variance of the first digital image would be substantially greater than the variance of the second digital image.

As used herein, to say that “the uniformity of the output light is substantially less than the uniformity of the input light” means that, if a first digital image of a screen were taken under Standard Conditions while the screen is illuminated by light that travels from a light source to a pattern projector and then to the screen, and a second digital image of the screen were taken under identical conditions except that the pattern generator is absent, then the uniformity of the first digital image would be substantially less than the uniformity of the second digital image.

As used herein, to say that “the average entropy of the output light is substantially greater than the average entropy of the input light” means that, if a first digital image of a screen were taken under Standard Conditions while the screen is illuminated by light that travels from a light source to a pattern projector and then to the screen, and a second digital image of the screen were taken under identical conditions except that the pattern generator is absent, then the average entropy of the first digital image would be substantially greater than the average entropy of the second digital image.

As used herein, to say that “the number of edge crossings of the output light is substantially greater than the number of edge crossings of the input light” means that, if a first digital image of a screen were taken under Standard Conditions while the screen is illuminated by light that travels from a light source to a pattern projector and then to the screen, and a second digital image of the screen were taken under identical conditions except that the pattern generator is absent, then the number of edge crossings of the first digital image would be substantially greater than the number of edge crossings of the second digital image.

As used herein, to say that “the spatial frequency factor of the output light is substantially greater than the spatial frequency factor of the input light” means that, if a first digital image of a screen were taken under Standard Conditions while the screen is illuminated by light that travels from a light source to a pattern projector and then to the screen, and a second digital image of the screen were taken under identical conditions except that the pattern generator is absent, then the spatial frequency factor of the first digital image would be substantially greater than the spatial frequency factor of the second digital image.

As used herein, to say that “the number of intensity peaks of the output light is substantially greater than the number of intensity peaks of the input light” means that, if a first digital image of a screen were taken under Standard Conditions while the screen is illuminated by light that travels from a light source to a pattern projector and then to the screen, and a second digital image of the screen were taken under identical conditions except that the pattern generator is absent, then the number of intensity peaks of the first digital image would be substantially greater than the number of intensity peaks of the second digital image.

The preceding six definitions do not mean that, in normal operation of this invention, the first and second images contemplated by these six definitions would actually be taken. Rather, each of the preceding six definitions precisely describe a difference between output light and input light, by stating what would be measured, if such first and second images were taken. For each of these six definitions, the contemplated difference between output light and input light either exists or does not exist, regardless of whether the first and second images are actually taken. For example, consider a statement that the variance of the output light is substantially greater than the variance of the input light. If this statement is true, then it is true regardless of whether such first and second images are actually taken.

In some cases, it is helpful to describe the effect of the pattern generator on local neighborhoods of an image. For example:

In illustrative implementations, the shape of the pattern generator is such that the variance of the output light is locally substantially greater than the variance of the input light.

In illustrative implementations, the shape of the pattern generator is such that the uniformity of the output light is locally substantially less than the uniformity of the input light.

In illustrative implementations, the shape of the pattern generator is such that the average entropy of the output light is locally substantially greater than the average entropy of the input light.

In illustrative implementations, the shape of the pattern generator is such that the number of edge crossings in the output light is locally substantially greater than the number of edge crossings of the input light.

In illustrative implementations, the shape of the pattern generator is such that the spatial frequency factor of the output light is locally substantially greater than the spatial frequency factor of the input light.

Illustrative implementations mentioned in each of the previous five paragraphs include: (a) an embodiment in which a pattern generator projects a pattern shown in FIG. 7B or FIG. 7C onto a scene, which scene has the base illumination shown in FIG. 7A; and (b) an embodiment in which the pattern generator has a shape shown in FIG. 6A, 6B, 6C or 6E.

This paragraph provides a definition for what it means for a variable to “locally” increase or decrease. Whether a variable “locally” increases (or decreases) from a first image to a second image is determined by comparing values of the variable in corresponding neighborhoods in the first and second image. Specifically, to say that a variable is “locally” greater in a first image than a second image means that the total number of neighborhoods in which the variable increases from the first to the second image is greater than the total number of neighborhoods in which the variable decreases from the first to the second image. Likewise, to say that a variable is “locally” less in a first image than a second image means that the total number of neighborhoods in which the variable decreases from the first to the second image is greater than the total number of neighborhoods in which the variable increases from the first to the second image. For purposes of this definition, the neighborhoods are created by subdividing each image into square, side-by-side, non-overlapping neighborhoods of 25×25 pixels, starting at the origin of the image (i.e., upper left corner of the image), and disregarding any portions of the image that do not fit into a complete 25×25 pixel neighborhood (e.g., along the bottom border or right border of the image.

It can be helpful to describe the local effect of a pattern generator by locally comparing a first image of a screen taken when a pattern generator is projecting light onto the screen and a second image of a screen taken under identical conditions, except that the pattern generator has been removed. For example, to say that the variance of the output light is “locally” substantially greater than the variance of the input light means that, if a first digital image of a screen were taken under Standard Conditions while the screen is illuminated by light that travels from a light source to a pattern projector and then to the screen, and a second digital image of the screen were taken under identical conditions except that the pattern generator is absent, then the variance of the first digital image would be locally substantially greater than the variance of the second digital image. The same approach (to defining what a “locally” substantial difference means) also applies to uniformity, average entropy, number of edge crossings, and spatial frequency factor.

To be clear, this invention does not require that, in normal operation, images be taken under Standard Conditions. For example, this invention does not require that images be taken of a screen, or that the images be 16.1 megapixel, or that only a single distant point source of light be used. The Standard Conditions are merely used for purposes of certain definitions.

Likewise, this invention does not require that, in normal operation, any local image processing be done with 25×25 pixel neighborhoods. The 25×25 pixel neighborhood is merely the subdivision scheme used in a definition of how variables “locally” increase or decrease.

In illustrative implementations, the outgoing, modified light that leaves the pattern generator comprises textured light. The pattern generator projects textured light unto the scene. In illustrative implementations, the projected light pattern has a high spatial frequency.

In some cases, a pattern generator comprises a refractive optical element, a reflective optical element, or a spatial light modulator (SLM).

In some cases, a pattern generator includes an external surface that includes planar faces, facets or regions. In some cases, a pattern generator has an external surface that includes curved regions. In some cases, a pattern generator is pierced by holes that extend from one side to an opposite side of the pattern generator.

FIGS. 6A and 6B each show a pattern generator that comprises a spatial light modulator (SLM). In FIG. 6A, the SLM is a pinhole mask 601. In FIG. 6B, the SLM is a liquid crystal display (LCD) 611, shown in cross-section. Alternatively, other types of SLMs are used.

In FIGS. 6A and 6B, light from illumination sources is selectively attenuated by the SLM 601, 611 to create a visual pattern. In some cases, an SLM (e.g., a pinhole mask) projects a temporally constant (static) pattern; in other cases, an SLM (e.g., an LCD) projects a temporally changing pattern.

FIG. 6C shows a pattern generator 621 that comprises a reflective optical element that includes an uneven, specular surface 623. The specular surface 623 has variations in elevation (e.g., “hill” 625 and “valley” 627). The specular surface 623 unevenly reflects light from illumination sources, thereby creating a visual pattern.

FIG. 6D shows a setup in which a relay mirror is used in conjunction with a reflective pattern generator. In the example shown in FIG. 6D, light leaves an illumination source 641, then reflects off a specular surface of the pattern generator 643, then reflects off a relay mirror 645, from which it reflects to the scene 647.

FIG. 6E shows a pattern generator 651 that comprises a refractive optical element. It refracts light from illumination sources, thereby creating a visual pattern. In FIG. 6E, the pattern generator 651 has multiple, nonparallel faces (e.g., 652, 653).

FIG. 6F shows a pattern generator 660 creating a visual pattern that has a significantly non-uniform intensity. In FIG. 6F, light rays (e.g., 666, 667, 668, 669, 670) that are leaving the pattern generator have a significantly non-uniform pattern of intensity. This significantly non-uniform pattern includes multiple large intensity peaks (e.g., peaks centered in the direction of light rays 668 and 670, respectively). In the example shown in FIG. 6F: (a) this significantly non-uniform pattern of intensity is present in light leaving the pattern generator, but is not present in incoming light rays striking the pattern generator (e.g., incident light rays 661, 662, 663, 664, 665); (b) these incoming light rays are from a distant point source of light 674, such as a single LED. In FIG. 6F, the relative intensity of a light ray is indicated by the thickness of the arrow representing the light ray, with thicker meaning higher intensity. In the example shown in FIG. 6F, light rays 668, 670 are more intense than the other rays, and strike a scene 671 at points 672, 673, respectively. The more intense light rays 668, 670 cause large intensity peaks at points 672, 673, respectively.

In some cases, the pattern generator is a reflective or refractive optical element (e.g., 621, 651) that creates caustic light patterns, when illuminated by one or more illumination sources. For example, in some cases, the caustic pattern includes bright patches and edges, which contrast with a darker background. In some cases, the surface geometry of the reflective or refractive element is chosen by an inverse caustic design algorithm, which starts with a desired caustic light pattern and computes a surface geometry that would create this caustic pattern. For example, in some implementations, well-known inverse caustic design techniques (such as those described by Thomas Kiser, Mark Pauly and others at the Computer Graphics and Geometry Laboratory at the École Polytechnique Fédérale de Lausanne (EPFL)) are used to determine a surface geometry, and then a reflective or refractive pattern generator is fabricated with this surface geometry.

In exemplary implementations, the pattern generator comprises an optical element with a shape such that, when the optical element is illuminated by light incident on the optical element: (a) the optical element reflects, refracts or selectively attenuates the light; and (b) the light leaves the optical element in a significantly non-uniform pattern of intensity.

In illustrative embodiments of this invention, the pattern generator comprises a patterned optical element.

As used herein, a “patterned optical element” (also called a “POE”) means an optical element with a shape such that, for at least one specific direction of incident light, the optical element reflects, refracts or selectively attenuates the incident light; and light leaving the optical element has a significantly non-uniform pattern of intensity, which pattern is not present in the incident light. For purposes of the preceding sentence: (a) “incident light” means light incident on the optical element, and (b) incident light is treated as being in a specific direction if it is emitted by a single, distant point source of light, which source is in that specific direction from the optical element. For example, an optical element that satisfies the first sentence of this paragraph for only one specific direction of incident light, and not for any other direction of incident light, is a POE. Also, for example, an optical element that satisfies that first sentence, when illuminated simultaneously by multiple directions of incident light, is a POE.

To be clear, the preceding definition of “patterned optical element” does not require that, in normal operation, a patterned optical element be illuminated in only one specific direction. When used in this invention, a patterned optical element is normally illuminated in multiple directions by multiple illumination sources.

“POE” is an acronym for “patterned optical element”.

In illustrative implementations, each pattern generator shown in FIGS. 1A, 1B, 2A-3F, 6A-6F, 8A comprises a patterned optical element. In illustrative implementations, each pattern generator discussed herein (including any pattern generator that increases variance, average entropy, number of intensity peaks, number of edge crossings, or spatial frequency factor, and any pattern generator that reduces uniformity) comprises a patterned optical element. Alternatively, any pattern generator shown in FIGS. 1A, 1B, 2A-3F, 6A-6F, 8A or discussed herein comprises a pattern generator other than a pattern generator.

In some implementations, the shape of the POE is such that, for at least one specific direction of incoming light, the POE projects a light pattern that has multiple large intensity peaks. In such implementations, if the POE projected the light pattern onto a screen and a digital image of a screen were captured under Standard Conditions, the image would include multiple large intensity peaks.

Notwithstanding anything to the contrary herein, however: (a) a single, simple lens that is spherical or cylindrical is not a “patterned optical element” or “pattern generator”; and (b) a single Serial Lens System is not a “patterned optical element” or “pattern generator”. As used herein, a “Serial Lens System” means a lens system in which (i) the optical elements of the system consist only of simple lenses that are each either spherical or cylindrical, and (ii) a light ray transmitted through the system travels through each lens of the system, one lens at a time

FIG. 7A shows a scene that is lit only by its base illumination, before the pattern generator shines projected light onto the scene. In FIG. 7A, a scene comprises a person 701 standing in front of two walls 703, 705 and a curtain 707. The curtain 707 has a rich visual texture. However, under the base illumination, walls 703, 705 have no or very little visual texture: they are generally featureless.

FIGS. 7B and 7C show the same scene, lit by both the base illumination and light from a pattern generator. In FIG. 7B, a pattern generator that is an SLM (not shown) projects a pattern 710 of bright areas onto the scene. In FIG. 7C, a pattern generator that is a refractive or specular optical element (not shown) projects a caustic light pattern 720 onto the scene. In FIG. 7C, the intensity pattern projected on the scene includes an edge 721 and a large intensity peak 722.

Under the base illumination shown in FIG. 7A, each wall 703, 705 is so lacking in visual texture that it would be difficult to find correspondence points in stereo images of that wall (and thus to calculate depth of the walls by triangulation from stereo images). Adding the light pattern from the pattern generator (as shown in FIGS. 7B and 7C) mitigates this problem. The projected light patterns 710, 720 in FIGS. 7B and 7C add visual texture to the scene, including the walls. This makes it easier to find correspondence points in stereo images of the walls (and thus to calculate the depth of the walls by triangulation).

In some implementations, one or more computers compute scene depth, then output control signals to cause a visual display screen to display the calculated depth information in a humanly-readable format. For example, in some cases, a depth map is displayed.

FIG. 7D shows a visual display device 730 displaying a depth map 731 for the scene shown in FIG. 7A. The depth map 731 conveys information about the depth of points in the scene. For example, in this depth map, region 735 (at the corner between the two walls) is marked differently than region 737 (at a wall), because these two scene regions are different scene depths.

In some implementations, multiple cameras capture near-infrared (NIR) images of a scene, and at least one camera captures a visible light image of a scene. One or more computers output control signals to cause a visual display screen to display calculated depth information, overlaid on an ordinary visible light image of the scene.

FIG. 7E is a chart showing the magnitude of six attributes of input light incident on a pattern generator and of output light leaving the pattern generator, in an illustrative implementation of this invention. In the example shown in FIG. 7E, the shape of the pattern generator is such that: (a) the variance of the output light (VR1) 741 is substantially greater than the variance of the input light (VR2) 742; (b) the uniformity of the output light (UN1) 743 is substantially less than the uniformity of the input light (UN2) 744; (c) the average entropy of the output light (AE1) 745 is substantially greater than the average entropy of the input light (AE2) 746; (d) the number of edge crossings of the output light (EC1) 747 is substantially greater than the number of edge crossings of the input light (EC2) 748; (e) the spatial frequency factor of the output light (SF1) 749 is substantially greater than the spatial frequency factor of the input light (SF2) 750; and (f) the number of intensity peaks of the output light (IP1) 751 is substantially greater than the number of intensity peaks of the input light (IP2) 752.

This invention is not limited to the particular shapes of the pattern generators shown in the FIGS. 6A-6F. Alternatively, other shapes of pattern generators are used. The pattern generators shown in FIGS. 1A, 1B, 3D, 3E, 4C, 4D, 5C, 5D, 5F, 8A, 8C symbolize any shape of pattern generator and are not limited, for example, to rectangular or cuboid shapes.

It is well-known that, starting with a projected pattern of light, one can calculate the surface geometry of an object (e.g., a reflective or refractive optical element or an SLM) that produces the projected pattern of light. For example, a conventional algorithm solves this “reverse design” problem for a reflective optical element by: (a) optimizing a 2D mesh representation of a specular surface; (b) then calculating a normal field from the deformed mesh that results from the optimization; and (c) and integrating to a height field surface.

For example, consider the following problem: given a desired grayscale intensity image, find the shape of a surface that will project a light pattern that reproduces this image. In some cases, a conventional “brightness warping” algorithm is used to solve this problem for a specular surface. In this conventional algorithm, the goal is formulated as an optimization problem. For the optimization, a fixed mesh is used to describe the light pattern, and the points on mesh of a specular surface which cast the corresponding rays are moved. The mesh of the specular surface is divided into quadangular patches which correspond to faces of the projected light mesh. By optimizing the area of these patches in the mesh for a specular surface, the brightness of the corresponding quads of the mesh for the projected light are adjusted to a desired distribution. The larger the area of a face in the warped mesh on the specular plane, the more light is projected on the unchanged area in the mesh for the projected light, increasing the brightness. Thus, the optimization deforms the mesh for the specular surface, such that the desired amounts of light are allocated to the corresponding faces of the mesh for the light pattern. The boundary vertices of the warped mesh (in the specular plane) are confined to remain on the border. Once the deformation of this mesh is computed, the normal field is obtained by interpolating the outgoing ray directions at the grid nodes using barycentric coordinates. The normal field is then integrated to a height field. Quadratic brightness constraints are employed. A consistency term is used to ensure intergrability.

A conventional “brightness warping” algorithm for a refractive object works in the same manner. For a reflective surface, a single height map is used. For a refractive object, there are two height maps: one for the surface where light enters the object and one for the surface where the light exits the object. But one of the refractive surfaces is assumed to be planar (and the incident light parallel), so the algorithm is run only on a single surface for a refractive object.

Also, well-known techniques can be employed to “reverse design” an SLM. Starting with a desired projected pattern of light, these techniques calculate an SLM that projects the light. In these calculations, conventional ray tracing is used for light rays that pass through apertures of the SLM without diffraction. In some cases, small apertures in an SLM create significant diffraction effects. In those cases, conventional formulas for modeling diffraction effects are employed.

Thus, by specifying a light pattern projected by a pattern generator, one specifies the structure (i.e., the shape) of the pattern generator. This applies for all pattern generators (including reflective or refractive pattern generators, and SLMs).

### Stereo Images and Distance Computations

In illustrative implementations, images are taken by two cameras placed apart from each other. The change in position (between the two images) of a near scene point is expected to be more than change in position (between the two images) of a far scene point. A computer uses this disparity in the features to determine, with simple triangulation, the depth of the features.

In exemplary implementations of this invention, a computer performs a conventional algorithm to determine depth by triangulation from the images taken by the multiple cameras.

Many conventional algorithms exist for determining depth by triangulation from two images taken by two cameras from different vantage points. The following four paragraphs provide a brief overview of some features of these conventional methods.

Conventionally, if information about the cameras used to take the images are known by calibration (such as their locations, focal lengths, etc.), the exact coordinates of each feature can be reconstructed and used to produce a three-dimensional model of the scene.

Conventionally, a computer performs an algorithm to compute depth by triangulation. Part of this algorithm determines which features of one image match to those of the other image (i.e., the algorithm solves what is known as the correspondence problem). Consider two cameras placed side by side and taking left and right image respectively of the scene. To find the depth of a feature on the left image, the algorithm first finds the corresponding feature on the right image. Instead of searching the complete right image, the search space is reduced by using the epipolar geometry constraint. A point on the left image can correspond to a point lying only on the epipolar line in the right image. This constraint reduces the search space from complete right image to just a line in the right image. The process of determining epipolar lines yields essential matrix and fundamental matrix for the camera pair.

Conventionally, the algorithm also includes steps collectively known as rectification. Rectification transforms the left and right images such that epipolar lines become horizontal. After the images have been rectified, for a pixel at the kth row of the transformed left image, the algorithm searches for correspondence along the kth row of the transformed image.

Many different conventional algorithms exist for determining depth by triangulation from stereo images. Typically, these algorithms include one or more of: (1) matching cost computation; (2) cost aggregation; (3) disparity computation/optimization; and (4) disparity refinement. Examples of some approaches include sum of squared differences, cross-correlations, graph cut methods, dynamic programming, scanline optimization, genetic algorithms, and stochastic diffusion.

As noted above, in exemplary embodiments of this invention, any of these conventional methods can be used to compute depth by triangulation from stereo images taking by multiple cameras.

In exemplary implementations of this invention, the cameras are calibrated to determine intrinsic and extrinsic parameters (encoded in the essential and fundamental matrices). These parameters are used to apply a projective transform that converts the disparity map into real world depth map.

In some implementations of this invention, one or more computers compute a rectification matrix (either automatically or in response to user input that signifies an instruction to do so). In some cases, the computers are also programmed to detect an error in a rectification matrix and, upon detecting the error, to compute a new, corrected rectification matrix. For example, changed conditions, such as changed temperature, sometimes causes baseline distances between cameras to change, and thereby cause a previously computed rectification matrix to become inaccurate. In that case, the computer would calculate a new, accurate rectification matrix.

In some implementations of this invention, one or more computers perform an algorithm to apply a low pass filter to images captured by the camera. The low pass filter tends to remove noise from the images. Also, the low pass filter tends to remove, from the images of the scene, any high spatial frequency light pattern projected onto the scene by the pattern generator.

### Hardware

In illustrative implementations, any type of camera is used, including any digital camera or digital video camera.

In illustrative embodiments, the pattern generator projects NIR light which has a visual texture in the NIR frequency spectrum. In these embodiments, the cameras capture NIR images, and any hot mirrors on the cameras are removed (or not functional). In some cases, full spectrum cameras (e.g., for capturing images in a range from 300 nm to 1000 nm) are used.

In some implementations, the illumination sources include one or more strobe lights, and the multiple cameras include one or more high-speed cameras. In some use scenarios, the strobe lights and high-speed cameras are used for capturing images of a rapidly moving object without blurring.

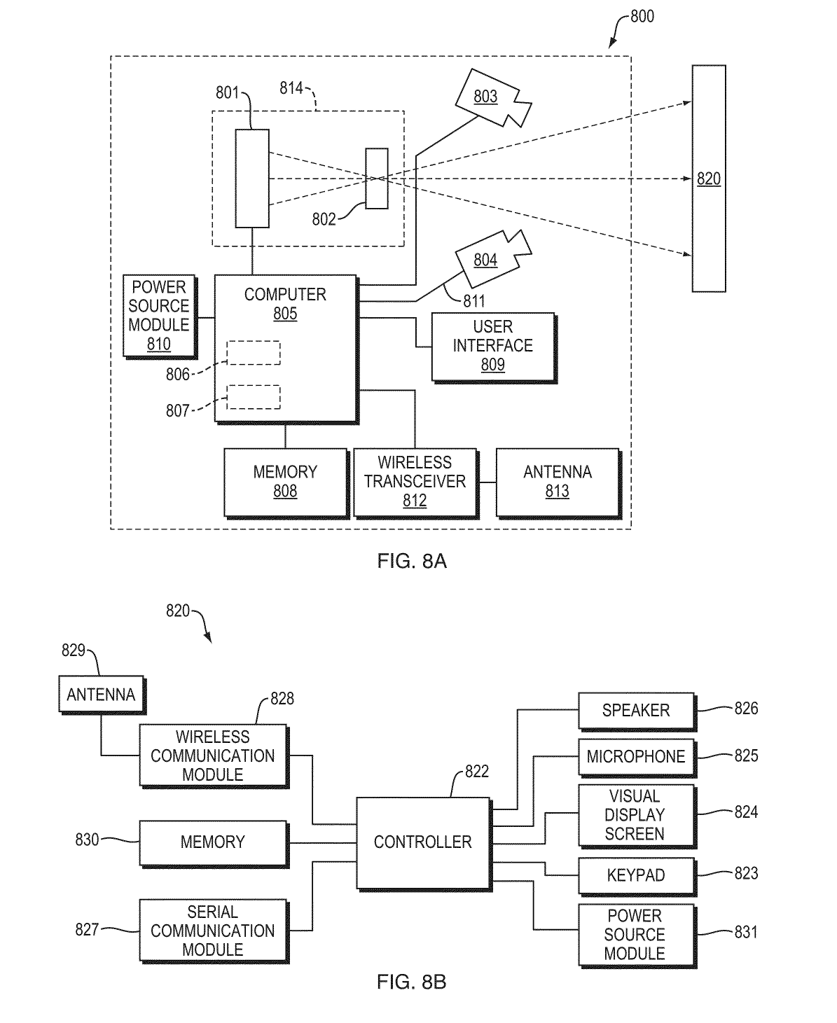

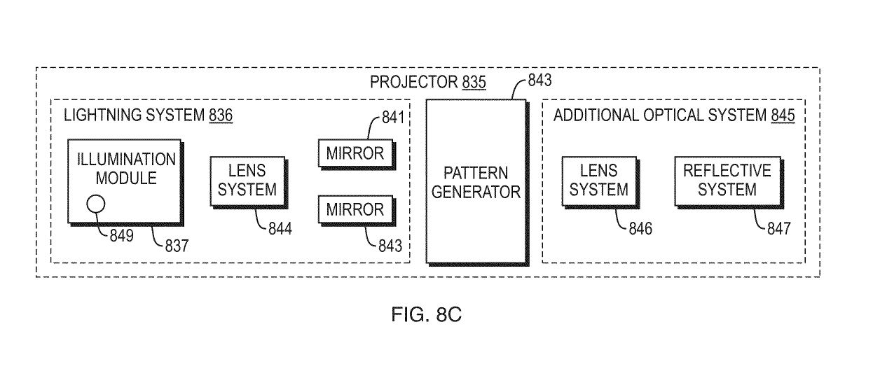

FIG. 8A is a high-level block diagram of hardware components of a depth-sensing system 800, in an illustrative implementation of this invention. In the example shown in FIG. 8A, a projector 814 includes an illumination module 801 and a pattern generator 802. The illumination module 801 comprises one or more illumination sources, including at least one active light source. The illumination sources illuminate the pattern generator 802, which in turn projects textured light unto a scene 820. A plurality of cameras 803, 804 captures images of the scene, while the scene is illuminated by the textured light. The images are taken from the different vantage points of the different cameras. One or more computers 805 process these images, and perform an algorithm to compute depth of points in the scene by steps that include rectification and triangulation. The one or more computers 805 include electronic processors 806 and electronic memory devices 807. In some cases, external memory devices 808 are used. A user interface module 809 accepts input from a human user and outputs information in humanly perceptible format.

The system 800 includes a power source module 810. In some cases, the power source module 810 steps down or rectifies power from a wall outlet. Lines (e.g. 811) between the above hardware components in FIG. 8A represent communication or power links between these components. For example, these links may be wired connections, wireless connections, or a combination of both. If a wireless connection is employed, then the system includes at least one wireless transceiver module (e.g., 812), and at least one antenna (e.g., 813).

User interface module 809 may vary, depending on the particular implementation of this invention. In some cases, user interface module 809 includes a combination of one or more of input devices (such as a touchscreen, contact-sensitive display, keypad, mouse, joystick, scroll-wheel, buttons, dials, sliders, microphone, haptic transducer, or motion sensing input device) and one or more output devices (such as a touchscreen or other visual display screen, projector, speaker, or haptic transducer).

FIG. 8B shows an example of a user interface module 820, in an embodiment of this invention. In FIG. 8B, user interface module 820 comprises a controller 822, a keypad 823, a visual display screen 824, a microphone 825, a speaker 826, serial communication electronics 827, a wireless communications module 828, an antenna 829, an electronic memory device 830, and a power source module 831. All of these components of user interface module 821 are operatively connected to each other by wired or wireless links. User interface module 820 is operatively linked to other components of the depth-finding system (e.g. cameras or projector) by wired or wireless connections.

In the example shown in FIG. 8B, the wireless communication module 828 is connected (via a wired electrical connection) to antenna 829. The wireless communication module 828 includes a transmitter and a receiver or a transceiver. The controller 822 provides signals to or receives signals from the wireless communication module 828. In some cases, the signals include signaling information in accordance with the air interface standard of an applicable cellular system. In some cases, the signals also include data corresponding to user speech, received data and/or user generated data. In some cases, the wireless communication module 828 operates in accordance with one or more first, second, third and/or fourth-generation cellular communication protocols or the like. Alternatively (or in addition) the user interface module 820 communicates with external devices via non-cellular communication mechanisms (including computer networks such as the Internet, local area network, wide area networks, and the like; short range wireless communication networks such as Bluetooth® networks, Zigbee® networks, Institute of Electric and Electronic Engineers (IEEE) 802.11x networks, and the like; or wireline telecommunication networks such as public switched telephone network (PSTN)).

In some cases, all or part of system 800 is mounted on a wall or affixed (at least semi-permanently) to another surface. For example, in some cases, multiple copies of the system are mounted at different points along a perimeter of a large room (e.g., in a store, restaurant, lobby, mall or other public space).

Alternatively, all or part of system 800 is housed in a portable electronic device. In some cases, some components of system 800 (e.g., the user interface 809) are housed or affixed at a location removed from other components of the system.

FIG. 8C is a conceptual diagram of a projector 835, in an illustrative implementation of this invention. In the example shown in FIG. 8C, the projector 835 includes a lighting system 836, a pattern generator 843, and (optionally) an additional optical system 845. Taken as a whole, projector 835 projects textured light unto a scene. The light adds visual texture to the scene.

The lighting system 836 includes an illumination module 837, which in turn includes one or more active light sources (e.g., 849). In some cases, lighting system 836 also includes one or more specular surfaces (e.g., mirrors 841, 843) for reflecting light from one or more active light sources. In some cases, lighting system 841 includes a lens system 844. The lighting system 836 illuminates the pattern generator 843.

Optionally, the projector 835 includes additional optical system 845. Light from the pattern generator 843 strikes the additional optical system 845. After exiting the additional optical system 845, outgoing light travels to the scene. The additional optical system 845 comprises a lens system 846, or a reflective system 847, or a combination of both. Reflective system 847 comprises one or more specular surfaces for reflecting light.

Each lens system 844, 846 comprises one or more lenses. Taken as a whole, each lens system 844, 846 comprises or is the functional equivalent of a positive lens (for converging light), a negative lens (for diverging light) or an optical element that transmits but neither converges nor diverges light.

The illumination modules shown in FIGS. 2A to 3F are non-limiting examples of illumination module 801 (in FIG. 8A). User interface module 820 (in FIG. 8B) is a non-limiting example of user interface module 809 (in FIG. 8A). Projector 835 (in FIG. 8C) is a non-limiting example of projector 814 (in FIG. 8A).

In illustrative implementations, hardware components of a depth-finding system are supported by one or more support structures (such as housing, beams, trusses, cantilevers, fixtures, fasteners, cables, or other components for supporting a load).

### Operation

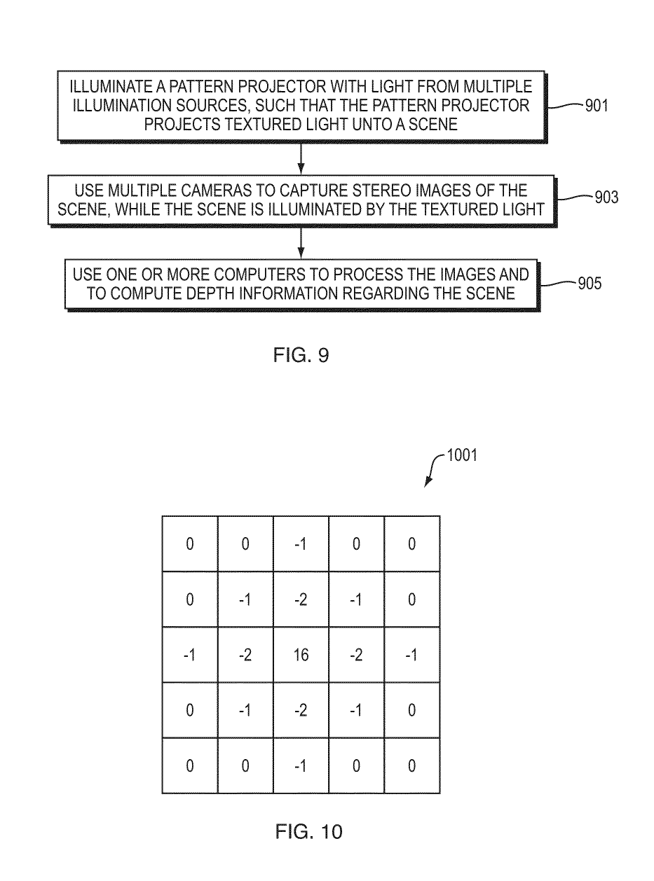

FIG. 9 shows steps of a depth-sensing method, in an illustrative embodiment of this invention. The steps comprise, in combination: Illuminate a pattern generator with light from multiple illumination sources, such that the pattern generator projects textured light unto a scene. 901 Use multiple cameras to capture stereo images of the scene, while the scene is illuminated by the textured light. 903 Use one or more computers to process the images and to compute depth information regarding the scene. 905

### Calibration

In some implementations, a calibration step includes turning light sources in the illumination module on and off.

For example, in some cases, turning light sources on and off, one at a time, makes it easier to register images and to calculate a correspondence matrix.

Also, for example, in some cases, light sources are turned on and off rapidly to determine any time difference between when an event is seen by different cameras taking a video of the scene from different vantage points. If in one video camera an event is first observed at T instant, and in another camera the event is first observed at T+t instant, then, in some cases, a computer uses an offset of time period ‘t’ between the cameras when processing images, in order to synchronize the cameras computationally.

### Variations

In some implementations, high wattage light sources are used to increase the range of distances over which depth can be sensed. For example, in some cases, high wattage LEDs in an illumination module are used to project an intense light pattern so that a bright textured light pattern is clearly visible at greater scene depths (e.g., at depths of 8-10 meters). The ability to measure depth at a large distance (e.g., 8-10 meters) is desirable in many settings, including, in some cases, in public places such as restaurants, banks, and office buildings.

In some implementations, the FOI of a single depth-sensing device is too small for the size of the scene. To solve that problem, multiple depth-sensing devices are employed (e.g., in different positions along the perimeter of a large room). Overlapping FOIs from different depth-sensing devices is generally not a problem. Instead, visual patterns in overlapping FOIs are added by superposition, making an even richer visual texture, and thereby facilitating depth detection.

In some cases, a computer processes an image and detects a moving object in the scene. The computer then sends control signals to power-on a selected set of one or more light sources, so that a textured light pattern is projected at a region in which the moving object is currently located, and not at other regions. For example, in some cases, a look-up table is stored in electronic memory and maps a light source (or a set of light sources) to a region of the scene that is illuminated by the light (or set of lights). A computer accesses the look-up table to determine which light sources to turn on to illuminate the moving object at its current location. In this example, illuminating only the region where the moving object is located reduces power consumption.

### Computers

In exemplary implementations of this invention, one or more electronic computers (e.g. 143, 183, 569, 599, 805, 822) are adapted: (1) to control the operation of, or interface with, hardware components of a depth-sensing device, including any light sources, cameras, or actuators; (2) to perform any calculation described above; including any calculation of a correlation matrix, rectification matrix or any computation of depth by triangulation; (3) to receive signals indicative of human input, (4) to output signals for controlling transducers for outputting information in human perceivable format, and (5) to process data, to perform computations, to execute any algorithm or software, and to control the read or write of data to and from memory devices. The one or more computers may be in any position or positions within or outside of the depth-sensing device. For example, in some cases (a) at least one computer is housed in or together with other components of the depth-sensing device, and (b) at least one computer is remote from other components of the depth-sensing device. The one or more computers may be connected to each other or to other components in the depth-sensing device either: (a) wirelessly, (b) by wired connection, or (c) by a combination of wired and wireless connections.

In exemplary implementations, one or more computers are programmed to perform any and all algorithms described herein, and any and all functions described in the immediately preceding paragraph. For example, in some cases, programming for a computer is implemented as follows: (a) a machine-accessible medium has instructions encoded thereon that specify steps in an algorithm; and (b) the computer accesses the instructions encoded on the machine-accessible medium, in order to determine steps to execute in the algorithm. In exemplary implementations, the machine-accessible medium comprises a tangible non-transitory medium. In some cases, the machine-accessible medium comprises (a) a memory unit or (b) an auxiliary memory storage device. For example, while a program is executing, a control unit in a computer may fetch the next coded instruction from memory.

In some cases, each computer includes or interfaces with one or more of the following features: a digital signal processor, microprocessor, a processor with accompanying digital signal processor, a processor without accompanying digital signal processor, a special-purpose computer chip, a field-programmable gate array, a controller, an application-specific integrated circuit, an analog to digital converter, a digital to analog converter, or a multi-core processor such as a dual or quad core processor.

### DEFINITIONS

The terms “a” and “an”, when modifying a noun, do not imply that only one of the noun exists.

“Active light source” is defined elsewhere in this document.

As a non-limiting example of “allowed intensity levels”, consider a grayscale image in which intensity is encoded by 8 bits, the lowest possible intensity level is 0, and the highest possible intensity level is 255. In this example, there are 256 “allowed intensity levels”, which are integers ranging from 0 to 255.

To say that projected light “adds visual texture” to a scene means that a significantly non-uniform pattern of intensity exists in the illumination of the scene when the scene is lit by both the projected light and the base lighting of the scene, which pattern is not present in the illumination of the scene when the scene is lit by only the base lighting of the scene. For purposes of the preceding sentence, “base lighting” means total illumination of the scene minus the projected light if any.

Here are some non-limiting examples of a “camera”: (a) a digital camera; (b) a video camera; (c) a NIR camera; and (d) a full spectrum camera (which images at least visible and NIR light).

“Average entropy” is defined elsewhere in this document.

The term “comprise” (and grammatical variations thereof) shall be construed as if followed by “without limitation”. If A comprises B, then A includes B and may include other things.

The term “computer” includes any computational device that performs logical and arithmetic operations. For example, in some cases, a “computer” comprises an electronic computational device, such as an integrated circuit, a microprocessor, a mobile computing device, a laptop computer, a tablet computer, a personal computer, or a mainframe computer. For example, in some cases, a “computer” comprises: (a) a central processing unit, (b) an ALU (arithmetic/logic unit), (c) a memory unit, and (d) a control unit that controls actions of other components of the computer so that encoded steps of a program are executed in a sequence. For example, in some cases, the term “computer” also includes peripheral units, including an auxiliary memory storage device (e.g., a disk drive or flash memory). However, a human is not a “computer”, as that term is used herein.

“Defined Term” means a term that is set forth in quotation marks in this Definitions section.

A point source of light that illuminates an object is “distant” from the object if the distance between the point source of light and the object is greater than ten times the maximum dimension of the object. For example, if a point source of light (such as a single LED) illuminates a pattern generator, the maximum dimension of the pattern generator is 4 cm, and the distance between the point source and the pattern generator is 45 cm, then the point source is “distant” from the pattern generator.

A “depth map” means (a) a set of data regarding depth of points in a scene, or (b) a visual display that conveys all or part of this data in humanly-perceptible format.

A “directional” light source means a light source that emits (or reflects or transmits) greater radiance in at least one direction than in other directions.

For an event to occur “during” a time period, it is not necessary that the event occur throughout the entire time period. For example, an event that occurs during only a portion of a given time period occurs “during” the given time period.

As used herein, an “edge” means a feature of an image that would be treated as an edge by a Marr-Hildreth edge detection algorithm, using a 5×5 LoG (LaPlacian of a Gaussian) mask, which 5×5 LoG mask has the values that are conceptually shown in mask 1001 in FIG. 10. To be clear, this edge detection method is specified here solely for definitional purposes, and nothing requires that this method actually be used in normal operation of this invention. Indeed, in normal operation of this invention, any method of edge detection is used, including Sobel, Marr-Hildreth or Canny edge detection methods.

The term “e.g.” means for example.

“Emission of photons” is defined elsewhere in this document.

The fact that an “example” or multiple examples of something are given does not imply that they are the only instances of that thing. An example (or a group of examples) is merely a non-exhaustive and non-limiting illustration.

Unless the context clearly indicates otherwise: (1) a phrase that includes “a first” thing and “a second” thing does not imply an order of the two things (or that there are only two of the things); and (2) such a phrase is simply a way of identifying the two things, respectively, so that they each can be referred to later with specificity (e.g., by referring to “the first” thing and “the second” thing later). For example, unless the context clearly indicates otherwise, if an equation has a first term and a second term, then the equation may (or may not) have more than two terms, and the first term may occur before or after the second term in the equation. A phrase that includes a “third” thing, a “fourth” thing and so on shall be construed in like manner.

“FOI” means field of illumination.

The term “for instance” means for example.

The term “frame” shall be construed broadly. For example, the term “frame” includes measured data about a scene that is captured by a camera during a single time period or single exposure, even if (i) the data is not humanly perceptible, (ii) the data has not been computationally processed, and (iii) there is not a one-to-one mapping between the data and the scene being imaged.

In the context of a camera (or components of the camera), “front” is optically closer to the scene being imaged, and “rear” is optically farther from the scene. In the context of a projector (or components of the projector), “front” is optically closer to the surface upon which light is projected by the projector, and “rear” is optically further from that surface. The “front” and “rear” of a camera or projector continue to be the front and rear, even when the camera or projector is not being used.

“Herein” means in this document, including text, specification, claims, abstract, and drawings.

The term “hole” means a hole, cavity, gap, opening or orifice.

The terms “horizontal” and “vertical” shall be construed broadly. For example, “horizontal” and “vertical” may refer to two arbitrarily chosen coordinate axes in a Euclidian two dimensional space, regardless of whether the “vertical” axis is aligned with the orientation of the local gravitational field. For example, a “vertical” axis may oriented along a local surface normal of a physical object, regardless of the orientation of the local gravitational field.

“Illumination source” is defined elsewhere in this document.

As used herein: (1) “implementation” means an implementation of this invention; (2) “embodiment” means an embodiment of this invention; (3) “case” means an implementation of this invention; and (4) “use scenario” means a use scenario of this invention.

The term “include” (and grammatical variations thereof) shall be construed as if followed by “without limitation”.

“Intensity” means any measure of or related to intensity, energy or power. For example, the “intensity” of light includes any of the following measures: irradiance, spectral irradiance, radiant energy, radiant flux, spectral power, radiant intensity, spectral intensity, radiance, spectral radiance, radiant exitance, radiant emittance, spectral radiant exitance, spectral radiant emittance, radiosity, radiant exposure or radiant energy density. Notwithstanding anything to the contrary herein, in the context of a digital image, “intensity” means a measure of achromatic light intensity, such as (1) grayscale intensity, (2) the intensity component of the HSI (hue, saturation, intensity) color model, or (3) luma.

As used herein, an “intensity peak” means a relative maximum of light intensity.

As used herein, a “large intensity peak” of an image means an intensity peak of the image, such that at least one specific pixel in the intensity peak has an intensity equal to the highest intensity in a square neighborhood of the image, which square neighborhood is centered at the specific pixel and has a size equal to at least one fiftieth of the total number of pixels in the image. Solely for purposes of the preceding sentence, if the specific pixel is so close to a border of the image that a portion of the square neighborhood would extend outside the border (and thus beyond the confines of the image) if the neighborhood were centered at the specific pixel, then the neighborhood is treated as if it extended outside the border and any pixel in the neighborhood that would be outside the border is treated as having an intensity of zero.

“Light” means electromagnetic radiation of any frequency. For example, “light” includes, among other things, visible light and infrared light. Likewise, any term that directly or indirectly relates to light (e.g., “imaging”) shall be construed broadly as applying to electromagnetic radiation of any frequency.

As used herein, (i) a single scalar is not a “matrix”, and (ii) one or more entries, all of which are zero (i.e., a so-called null matrix), is not a “matrix”.

The “maximum dimension” of an object is the longest Euclidian distance between any two points on the exterior surface of the object.

The term “mobile computing device” or “MCD” includes any of the following electronic devices: a smartphone, cell phone, mobile phone, phonepad, tablet, laptop, notebook, notepad, personal digital assistant, enterprise digital assistant, ultra-mobile PC, or any handheld computing device. A device may be an MCD even if it is not configured for direct or indirect connection to an internet or world wide web.

“Multiple edges” is defined elsewhere in this document.

To “multiply” includes to multiply by an inverse. Thus, to “multiply” includes to divide.

“NIR” means near infrared.

“Number of edges” is defined elsewhere in this document.

The term “optical element” is not limited to a refractive optical element (e.g., a lens) or a reflective optical element (e.g., a mirror). In some cases, an optical element is an SLM.

The term “or” is inclusive, not exclusive. For example A or B is true if A is true, or B is true, or both A or B are true. Also, for example, a calculation of A or B means a calculation of A, or a calculation of B, or a calculation of A and B.

“Passive light source” is defined elsewhere in this document.

“Patterned optical element” is defined elsewhere in this document.

To “point” a directional illumination source in a given direction means to orient the illumination source such that the radiance leaving the illumination source in the given direction is greater than or equal to the radiance leaving the illumination source in any other direction.

To “program” means to encode, in tangible, non-transitory, machine-readable media, instructions for a computer program. To say that a computer is “programmed” to perform a task means that instructions for the computer to perform the task are encoded in tangible, non-transitory, machine-readable media, such that the instructions are accessible to the computer during operation of the computer.

To say that an object “projects” light means that the light leaves the object (e.g., by reflection, refraction or transmission).

A parenthesis is simply to make text easier to read, by indicating a grouping of words. A parenthesis does not mean that the parenthetical material is optional or can be ignored.

To say that an object “selectively attenuates” light means that the object non-uniformly attenuates the light, such that the amount of attenuation of a light ray incident at a point on a surface of the object depends on at least the 2D spatial position of the point on the surface

As used herein, the term “set” does not include a so-called empty set (i.e., a set with no elements). Mentioning a first set and a second set does not, in and of itself, create any implication regarding whether or not the first and second sets overlap (that is, intersect).

The “shape” of an SLM includes the spatial pattern of light-transmitting and light-attenuating areas of the SLM. For example, the “shape” of a pinhole mask includes the spatial pattern of the mask holes (which transmit light) and of the mask opaque regions (which block light). Also, for example, the “shape” of an LCD includes the spatial arrangement of LCD pixels that attenuate light by different amounts. Also, in some cases, the “shape” of an LCD includes the shape of twisted nematic crystals or other liquid crystals in the LCD pixels, which in turn determine degree of attenuation of light incident on the LCD pixels.

To say that a pattern of intensity is “significantly non-uniform” means that, in the pattern, intensity as a function of spatial position is not substantially constant.

“Some” means one or more.

“Spatial frequency factor” is defined elsewhere in this document.

A “spatial light modulator”, also called an “SLM”, means a device that (i) either transmits light through the device or reflects light from the device, and (ii) attenuates the light, such that the amount of attenuation of a light ray incident at a point on a surface of the device depends on at least the 2D spatial position of the point on the surface. A modulation pattern displayed by an SLM may be either time-invariant or time-varying.

“Standard Conditions” is defined elsewhere in this document.

As used herein, a “subset” of a set consists of less than all of the elements of the set.

A “substantial” increment of a value means a change of at least 10% in that value. For example: “Substantially increase” means to increase by at least 10 percent. “Substantially decrease” means to decrease by at least 10 percent. To say that a value X is “substantially greater” than a value Y means that X is at least 10 percent greater than Y, that is X≧(1.1)Y. To say that a value X is “substantially less” than a value Y means that X is at least 10 percent less than Y, that is X≦(0.9)Y.

To say that a value is “substantially constant” means that at least one constant number exists, such that the value is always within a single range, where: (a) the bottom of the range is equal to the constant number minus ten percent of the constant number; and (b) the top of the range is equal to the constant number plus ten percent of the constant number.

The term “such as” means for example.

“Uniformity” is defined elsewhere in this document.

“Variation” is defined elsewhere in this document.

“Visual texture” is defined elsewhere in this document.

Spatially relative terms such as “under”, “below”, “above”, “over”, “upper”, “lower”, and the like, are used for ease of description to explain the positioning of one element relative to another. The terms are intended to encompass different orientations of an object in addition to different orientations than those depicted in the figures.

A matrix may be indicated by a bold capital letter (e.g., D). A vector may be indicated by a bold lower case letter (e.g., α). However, the absence of these indicators does not indicate that something is not a matrix or not a vector.

Except to the extent that the context clearly requires otherwise, if steps in a method are described herein, then: (1) steps in the method may occur in any order or sequence, even if the order or sequence is different than that described; (2) any step or steps in the method may occur more than once; (3) different steps, out of the steps in the method, may occur a different number of times during the method, (4) any step or steps in the method may be done in parallel or serially; (5) any step or steps in the method may be performed iteratively; and (6) the steps described are not an exhaustive listing of all of the steps in the method, and the method may include other steps.

This Definitions section shall, in all cases, control over and override any other definition of the Defined Terms. For example, the definitions of Defined Terms set forth in this Definitions section override common usage or any external dictionary. If a given term is explicitly or implicitly defined in this document, then that definition shall be controlling, and shall override any definition of the given term arising from any source (e.g., a dictionary or common usage) that is external to this document. If this document provides clarification regarding the meaning of a particular term, then that clarification shall, to the extent applicable, override any definition of the given term arising from any source (e.g., a dictionary or common usage) that is external to this document. To the extent that any term or phrase is defined or clarified herein, such definition or clarification applies to any grammatical variation of such term or phrase, taking into account the difference in grammatical form. For example, the grammatical variations include noun, verb, participle, adjective, or possessive forms, or different declensions, or different tenses. In each case described in this paragraph, Applicant is acting as Applicant's own lexicographer.

More Examples:

This invention may be implemented in many different ways. Here are some non-limiting examples:

In one aspect, this invention is a system comprising: (a) a set of multiple light sources; (b) a pattern generator for projecting light, when the pattern generator is illuminated by the multiple light sources; (c) multiple cameras for capturing, from different viewpoints, images of a scene illuminated by the light; and (d) one or more computers for processing the images and computing the depth of different points in the scene, by a computation that involves triangulation. In some cases, the pattern generator comprises a refractive optical element. In some cases, the system further comprises a positive lens positioned such that (a) the positive lens is in an optical path between the pattern generator and a given light source, out of the set of multiple light sources; and (b) the focal length of the positive lens is greater than the distance between the positive lens and the given light source. In some cases, the system further comprises actuators for translating at least some of the multiple light sources relative to the pattern generator, or for rotating at least some of the multiple light sources. In some cases, the system further comprises mirrors that: (a) are positioned for reflecting light from one or more of the light sources to the pattern generator; and (b) cause the maximum angle subtended by two light sources out of the multiple light sources, when viewed from the pattern generator, to be greater than such angle would be in the absence of the mirrors. Each of the cases described above in this paragraph is an example of the system described in the first sentence of this paragraph, and is also an example of an embodiment of this invention that may be combined with other embodiments of this invention.

In another aspect, this invention is a system comprising: (a) a set of multiple illumination sources; (b) a patterned optical element (POE), which POE is positioned such that each illumination source in the set is in a different direction, relative to the POE, than the other illumination sources in the set, and such that an optical path exists for light from each of the illumination sources to travel to the POE; (c) multiple cameras for capturing, from different viewpoints, images of a scene illuminated by output light that leaves the POE; and (d) one or more computers that are programmed to process the images and to compute the depth of different points in the scene, by a computation that involves triangulation. In some cases, the POE comprises a spatial light modulator. In some cases, the POE comprises a reflective optical element that includes a specular surface. In some cases, the POE comprises a refractive optical element. In some cases, the POE has a shape such that, when the POE is illuminated by input light and output light leaves the POE, the number of edge crossings in the output light is greater than the number of edge crossings in the input light. In some cases, the POE has a shape such that, when the POE is illuminated by input light and output light leaves the POE, the spatial frequency factor of the output light is greater than the spatial frequency factor of the input light. In some cases, the POE has a shape such that, when the POE is illuminated by input light and output light leaves the POE, the variance of the output light is greater than the variance of the input light. In some cases, the one or more computers are programmed to output control signals to control at least one illumination source in the set and to control the multiple cameras, such that the images are captured while the at least one illumination source illuminates the POE. In some cases, an angle subtended by two illumination sources, out of the multiple illumination sources, when viewed from the viewpoint of the POE, exceeds sixty degrees. In some cases, the system further comprises a positive lens positioned such that (a) the positive lens is in an optical path between the POE and a given light source, out of the set of multiple light sources; and (b) the focal length of the positive lens is greater than the distance between the positive lens and the given light source. In some cases, the system further comprises one or more actuators for translating one or more illumination sources, mirrors or lenses. In some cases, the system further comprises mirrors that: (a) are positioned for reflecting light from one or more of the light sources to the POE; and (b) cause the maximum angle subtended by two light sources out of the multiple light sources, when viewed from the POE, to be greater than such angle would be in the absence of the mirrors. Each of the cases described above in this paragraph is an example of the system described in the first sentence of this paragraph, and is also an example of an embodiment of this invention that may be combined with other embodiments of this invention.

In another aspect, this invention is a method comprising, in combination: (a) using multiple light sources to illuminate an optical element, such that the optical element projects light that adds visual texture to a scene; (b) using multiple cameras for capturing, from different viewpoints, images of the scene illuminated by the light; and (c) using one or more computers to process the images and to compute the depth of different points in the scene, by a computation that involves triangulation. In some cases, the optical element comprises a patterned optical element. In some cases, the method further comprises using a display screen to display a depth map, or outputting control signals to control display of a depth map. Each of the cases described above in this paragraph is an example of the method described in the first sentence of this paragraph, and is also an example of an embodiment of this invention that may be combined with other embodiments of this invention.

While exemplary implementations are disclosed, many other implementations will occur to one of ordinary skill in the art and are all within the scope of the invention. Each of the various embodiments described above may be combined with other described embodiments in order to provide multiple features. This invention includes not only the combination of all identified features but also includes each combination and permutation of one or more those features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also within the scope of the present invention. Numerous modifications may be made by one of ordinary skill in the art without departing from the scope of the invention.

What is claimed is:

1. A system comprising:
(a) a set of multiple light sources;
(b) a pattern generator for projecting light, when the pattern generator is illuminated by the multiple light sources;
(c) multiple cameras for capturing, from different viewpoints, images of a scene illuminated by the light; and
(d) one or more computers for processing the images and computing the depth of different points in the scene, by a computation that involves triangulation.

2. The system of claim 1, wherein the pattern generator comprises a refractive optical element.

3. The system of claim 1, further comprising a positive lens positioned such that
(a) the positive lens is in an optical path between the pattern generator and a given light source, out of the set of multiple light sources; and
(b) the focal length of the positive lens is greater than the distance between the positive lens and the given light source.

4. The system of claim 1, further comprising actuators for translating at least some of the multiple light sources relative to the pattern generator, or for rotating at least some of the multiple light sources.

5. The system of claim 1, further comprising mirrors that:
(a) are positioned for reflecting light from one or more of the light sources to the pattern generator; and
(b) cause the maximum angle subtended by two light sources out of the multiple light sources, when viewed from the pattern generator, to be greater than such angle would be in the absence of the mirrors.

6. A system comprising:
(a) a set of multiple illumination sources;
(b) a patterned optical element (POE), which POE is positioned such that each illumination source in the set is in a different direction, relative to the POE, than the other illumination sources in the set, and such that an optical path exists for light from each of the illumination sources to travel to the POE;
(c) multiple cameras for capturing, from different viewpoints, images of a scene illuminated by output light that leaves the POE; and
(d) one or more computers that are programmed to process the images and to compute the depth of different points in the scene, by a computation that involves triangulation.

7. The system of claim 6, wherein the POE comprises a spatial light modulator.

8. The system of claim 6, wherein the POE comprises a reflective optical element that includes a specular surface.

9. The system of claim 6, wherein the POE comprises a refractive optical element.

10. The system of claim 6, wherein the POE has a shape such that, when the POE is illuminated by input light and output light leaves the POE, the number of edge crossings in the output light is greater than the number of edge crossings in the input light.

11. The system of claim 6, wherein the POE has a shape such that, when the POE is illuminated by input light and output light leaves the POE, the spatial frequency factor of the output light is greater than the spatial frequency factor of the input light.

12. The system of claim 6, wherein the POE has a shape such that, when the POE is illuminated by input light and output light leaves the POE, the variance of the output light is greater than the variance of the input light.

13. The system of claim 6, wherein the one or more computers are programmed to output control signals to control at least one illumination source in the set and to control the multiple cameras, such that the images are captured while the at least one illumination source illuminates the POE.

14. The system of claim 6, wherein an angle subtended by two illumination sources, out of the multiple illumination sources, when viewed from the viewpoint of the POE, exceeds sixty degrees.

15. The system of claim 6, further comprising a positive lens positioned such that
(a) the positive lens is in an optical path between the POE and a given light source, out of the set of multiple light sources; and
(b) the focal length of the positive lens is greater than the distance between the positive lens and the given light source.

16. The system of claim 6, further comprising one or more actuators for translating one or more illumination sources, mirrors or lenses.

17. The system of claim 6, further comprising mirrors that:
(a) are positioned for reflecting light from one or more of the light sources to the POE; and
(b) cause the maximum angle subtended by two light sources out of the multiple light sources, when viewed from the POE, to be greater than such angle would be in the absence of the mirrors.

18. A method comprising, in combination:
(a) using multiple light sources to illuminate an optical element, such that the optical element projects light that adds visual texture to a scene;
(b) using multiple cameras for capturing, from different viewpoints, images of the scene illuminated by the light; and
(c) using one or more computers to process the images and to compute the depth of different points in the scene, by a computation that involves triangulation.

19. The method of claim 18, wherein the optical element comprises a patterned optical element.

20. The method of claim 18, further comprising using a display screen to display a depth map, or outputting control signals to control display of a depth map.
